(19) United States
(12) Patent Application Publication
(10) Pub. No.: US 2026/0030522 A1
(43) Pub. Date: Jan. 29, 2026

(54) KNOWLEDGE GRAPH CONSTRUCTION USING GENERATIVE ARTIFICIAL INTELLIGENCE FOR INTENT CLASSIFICATION

(71) Applicant: ADP, Inc., Roseland, NJ (US)

(72) Inventors: Bingyang Wen, Bayonne, NJ (US); Knarig Arabshian-pascarella, New York, NY (US)

(73) Assignee: ADP, Inc., Roseland, NJ (US)

(21) Appl. No.: 19/278,413

(22) Filed: Jul. 23, 2025

Related U.S. Application Data
(60) Provisional application No. 63/675,090, filed on Jul. 24, 2024.

(51) Int. Cl. G06N 5/022; G06F 16/28; G06F 16/31; G06F 16/35

(52) U.S. Cl. CPC G06N 5/022; G06F 16/282; G06F 16/316; G06F 16/35

(57) ABSTRACT

This application is directed to constructing a knowledge graph using generative artificial intelligence. A system can include one or more processors coupled with memory to identify a plurality of items of unstructured data. The system can provide, for one or more generative artificial intelligence models, a first prompt to cause the models to output a plurality of first level categories of a hierarchical data structure for the items. The system can receive the first level categories, each corresponding to a subset of the items grouped by semantic similarity, and evaluate each category according to taxonomy criteria. The system can provide a second prompt to generate second level categories for each first level category, receive the second level categories, and construct a knowledge graph data structure linking the categories and their respective subsets to relate each item of unstructured data with corresponding categories according to the hierarchical data structure.

### CROSS-REFERENCES TO RELATED APPLICATIONS

This application claims the benefit of priority under 35 U.S.C. § 119 to U.S. Provisional Patent Application No. 63/675,090, titled “KNOWLEDGE GRAPH CONSTRUCTION USING GENERATIVE ARTIFICIAL INTELLIGENCE,” filed Jul. 24, 2024, which is hereby incorporated by reference herein in its entirety and for all purposes.

### TECHNICAL FIELD

This application is generally directed to computing technology and, more particularly, to the construction of a knowledge graph using generative artificial intelligence.

### BACKGROUND

Computing infrastructure can classify digital or electronic documents using an ontology. However, as the digital documents may have increasingly varying categories, it can be technically challenging to accurately classify such documents in an efficient manner, let alone update the ontology in a reliable and efficient manner, without introducing excessive errors, delays, or computing processing delays.

### SUMMARY

Aspects of technical solutions described in this application are directed to generating and managing a knowledge graph data structure using generative artificial intelligence. The generation of artificial intelligence described herein can utilize unstructured user query data to generate multi-level taxonomies and relate subsequent incoming queries to structured knowledge representations for response generation. The technical solutions can be implemented in a data processing system that can utilize the generated multi-layer knowledge graph data structure to automatically process user queries and provide responses based on multi-layer data categories. However, due to the increasing variety of queries, or increasingly complex or changing configurations or types of response generation techniques, it can be technically challenging to efficiently and reliably generate, maintain, or update a knowledge graph tree structure, increasingly the likelihood of incorrect or erroneous classification of the queries, and inefficient or erroneous processing of the queries using the classification to generate responses.

To address these and other technical challenges, aspects of the technical solutions described herein can use generative artificial intelligence to construct or build a knowledge graph data structure using historical queries. The technology, using generative artificial intelligence models, can iteratively generate a taxonomy from the historical queries at various levels of granularity, while evaluating each level using taxonomy criteria prior to iterating to the next sub-level. Upon generating categories at multiple levels, the technology can construct, build, assemble, or otherwise generate a knowledge graph data structure linking the categories together.

Thus, aspects of the technical solutions described herein can automatically (e.g., fully automated without any human intervention) generate a knowledge graph data structure with a taxonomy or ontology at various levels of granularity. The technical solutions described herein can mitigate, minimize, prevent, or otherwise reduce hallucinations from the generative artificial intelligence by using historical queries and a taxonomy evaluator and modifier. Further, the technical solutions described herein can avoid having to apply a deduplication process due to the top-down category generation approach.

At least one aspect of the technical solutions described herein relates to a system. The system can include one or more processors coupled with memory. The system can identify a plurality of items of unstructured data. The system can provide, for one or more generative artificial intelligence models, a first prompt to cause the one or more generative artificial intelligence models to output a plurality of first level categories of a hierarchical data structure for the plurality of items. The system can receive, responsive to the first prompt and the plurality of items input into the one or more generative artificial intelligence models, the plurality of first level categories. Each first level category of the plurality of first level categories can correspond to a respective first level subset of the plurality of items. The first level subset can be grouped according to a semantic similarity operation performed on the plurality of items. The system can evaluate, via the one or more generative artificial intelligence models, each first level category of the plurality of first level categories according to one or more taxonomy criteria for the plurality of first level categories of the hierarchical data structure. The system can provide, responsive to the evaluation, for the one or more generative artificial intelligence models, a second prompt to cause the one or more generative artificial intelligence models to output a plurality of second level categories of the hierarchical data structure for each first level category of the plurality of first level categories. The system can receive, for each first level category, responsive to the second prompt input into the one or more generative artificial intelligence models, the plurality of second level categories. Each second level category of the plurality of second level categories can correspond to a respective second level subset of the plurality of items of unstructured data within a corresponding first level subset of the respective first level category. The second level subset can be grouped according to a semantic similarity operation performed on the respective first level subset. The system can construct, using the one or more generative artificial intelligence models, a knowledge graph data structure that links each of the plurality of first level categories and their respective first level subsets with second level categories and respective second level subsets within the respective first level subset to relate each of the plurality of items of unstructured data with a corresponding first level category of the plurality of first level categories and a corresponding second level category of the plurality of second level categories according to the hierarchical data structure.

The system can receive, from a remote device, a query comprising content corresponding to a topic. In some implementations, the system can identify, based on the content and the knowledge graph data structure, a first level category of the plurality of first level categories and a second level category of the plurality second level categories within the first level category. In some implementations, the system can select, based on the second level category, an item of the plurality of items corresponding to the topic. In some implementations, the system can provide, to the remote device responsive to the query, a response based on the item.

The system can modify, responsive to the evaluation, at least a first level category of the plurality of first level categories to satisfy the one or more taxonomy criteria. In some implementations, the system can provide the second prompt for the one or more generative artificial intelligence models, responsive to confirmation that each first level category of the plurality of first level categories satisfies the one or more taxonomy criteria.

The system can evaluate, via the one or more generative artificial intelligence models, each second level category of the plurality of second level categories according to one or more taxonomy criteria for the plurality of second level categories of the hierarchical data structure. In some implementations, the system can construct the knowledge graph data structure, responsive to the evaluation of each second level category. In some implementations, the system can further modify at least a second level category of the plurality of first level categories, responsive to the evaluation of each second level category.

The taxonomy criteria comprise at least one of: a threshold corresponding to a proportion of the plurality of items assigned to at least one of the first level categories and the second level categories, an inter-model agreement score determined from parallel classifications by two or more generative artificial intelligence models, a category size threshold corresponding to a number of items grouped in each category of the second level categories, a label clarity threshold corresponding to unambiguity of category labels within a subject matter domain, or a category overlap threshold corresponding to a limitation of a number of items of the plurality of items that are assigned to more than one category within a hierarchy level.

The system can generate an embedding vector for each item of the plurality of items of unstructured data using machine learning. In some implementations, the system can group subsets of the plurality of items based on a similarity metric applied to the embedding vectors during the semantic similarity operation. In some implementations, the first prompt comprises a representation of at least one example taxonomy or an example knowledge graph data structure.

The system can generate, using the one or more generative artificial intelligence models, a first layer label for each first level category of the plurality of first level categories based on a subject matter associated with the plurality of items of unstructured data within the corresponding first level subset. In some implementations, the system can generate, using the one or more generative artificial intelligence models, a second layer label for each second level category of the plurality of second level categories based on a context of the corresponding first level category to which the second level category belongs and a subset of a subject matter domain that corresponds to the corresponding first level category.

The system can determine, for each first level category of the plurality of first level categories, a first level category membership score based on a similarity operation performed between a representative item for the respective first level category and remaining items of unstructured data within the respective first level category. In some implementations, the system can determine, for each second level category of the plurality of second level categories, a second level category membership score based on a similarity operation performed between a representative item for the respective second level category and remaining items of unstructured data within the respective second level category.

The system can compare each first level category membership score to a first threshold value and, for each first level category with a membership score below the first threshold value, modify the respective first level category. In some implementations, the system can compare each second level category membership score to a second threshold value and, for each second level category with a membership score below the second threshold value, modify the respective second level category.

The modification of the respective first level category or the second level category includes at least one of: merging the respective category with a related category, splitting the respective category into two or more categories, removing the respective category, reassigning one or more items to a different category, or assigning a new label to the respective category. The system can provide, for at least one second level category of the plurality of second level categories, a third prompt to cause the one or more generative artificial intelligence models to output a plurality of third level categories for the respective second level category.

The system can receive, for each of the second level categories provided to the one or more generative artificial intelligence models, a plurality of third level categories, each third level category corresponding to a third level subset of items of unstructured data within a respective second level subset, the third level subset grouped according to a semantic similarity operation performed on the respective second level subset. The system can generate, using the one or more generative artificial intelligence models, a third layer label for each third level category based on context associated with the respective second level category and domain associated with the respective second level category.

At least one aspect of the technical solutions described herein relates to a method. The method can be performed, for example, by one or more processors coupled to non-transitory memory. The method can include identifying a plurality of items of unstructured data. The method can include providing, for one or more generative artificial intelligence models, a first prompt to cause the one or more generative artificial intelligence models to output a plurality of first level categories of a hierarchical data structure for the plurality of items. The method can include receiving, responsive to the first prompt and the plurality of items input into the one or more generative artificial intelligence models, the plurality of first level categories, each first level category of the plurality of first level categories corresponding to a respective first level subset of the plurality of items, the first level subset grouped according to a semantic similarity operation performed on the plurality of items. The method can include evaluating, via the one or more generative artificial intelligence models, each first level category of the plurality of first level categories according to one or more taxonomy criteria for the plurality of first level categories of the hierarchical data structure. The method can include providing, responsive to the evaluation, for the one or more generative artificial intelligence models, a second prompt to cause the one or more generative artificial intelligence models to output a plurality of second level categories of the hierarchical data structure for each first level category of the plurality of first level categories. The method can include receiving, for each first level category, responsive to the second prompt input into the one or more generative artificial intelligence models, the plurality of second level categories, each second level category of the plurality of second level categories corresponding to a respective second level subset of the plurality of items of unstructured data within a corresponding first level subset of the respective first level category, the second level subset grouped according to a semantic similarity operation performed on the respective first level subset. The method can include constructing, using the one or more generative artificial intelligence models, a knowledge graph data structure that links each of the plurality of first level categories and their respective first level subsets with second level categories and respective second level subsets within the respective first level subset to relate each of the plurality of items of unstructured data with a corresponding first level category of the plurality of first level categories and a corresponding second level category of the plurality of second level categories according to the hierarchical data structure.

The method can include receiving, from a remote device, a query comprising content corresponding to a topic. In some implementations, the method can include identifying, based on the content and the knowledge graph data structure, a first level category of the plurality of first level categories and a second level category of the plurality second level categories within the first level category. In some implementations, the method can include selecting, based on the second level category, an item of the plurality of items corresponding to the topic. In some implementations, the method can include providing, to the remote device responsive to the query, a response based on the item.

The method can include modifying, responsive to the evaluation, at least a first level category of the plurality of first level categories to satisfy the one or more taxonomy criteria. In some implementations, the method can include providing the second prompt for the one or more generative artificial intelligence models, responsive to confirmation that each first level category of the plurality of first level categories satisfies the one or more taxonomy criteria. In some implementations, the method can include evaluating, via the one or more generative artificial intelligence models, each second level category of the plurality of second level categories according to one or more taxonomy criteria for the plurality of second level categories of the hierarchical data structure. In some implementations, the method can include constructing the knowledge graph data structure, responsive to the evaluation of each second level category.

At least one other aspect of the technical solutions described herein relates to a non-transitory computer readable media storing instructions, which when executed by one or more processors, cause the one or more processors to identify a plurality of items of unstructured data. The instructions can cause the one or more processors to provide, for one or more generative artificial intelligence models, a first prompt to cause the one or more generative artificial intelligence models to output a plurality of first level categories of a hierarchical data structure for the plurality of items. The instructions can cause the one or more processors to receive, responsive to the first prompt and the plurality of items input into the one or more generative artificial intelligence models, the plurality of first level categories, each first level category of the plurality of first level categories corresponding to a respective first level subset of the plurality of items, the first level subset grouped according to a semantic similarity operation performed on the plurality of items. The instructions can cause the one or more processors to evaluate, via the one or more generative artificial intelligence models, each first level category of the plurality of first level categories according to one or more taxonomy criteria for the plurality of first level categories of the hierarchical data structure. The instructions can cause the one or more processors to provide, responsive to the evaluation, for the one or more generative artificial intelligence models, a second prompt to cause the one or more generative artificial intelligence models to output a plurality of second level categories of the hierarchical data structure for each first level category of the plurality of first level categories. The instructions can cause the one or more processors to receive, for each first level category, responsive to the second prompt input into the one or more generative artificial intelligence models, the plurality of second level categories, each second level category of the plurality of second level categories corresponding to a respective second level subset of the plurality of items of unstructured data within a corresponding first level subset of the respective first level category, the second level subset grouped according to a semantic similarity operation performed on the respective first level subset. The instructions can cause the one or more processors to construct, using the one or more generative artificial intelligence models, a knowledge graph data structure that links each of the plurality of first level categories and their respective first level subsets with second level categories and respective second level subsets within the respective first level subset to relate each of the plurality of items of unstructured data with a corresponding first level category of the plurality of first level categories and a corresponding second level category of the plurality of second level categories according to the hierarchical data structure.

An aspect of the technical solutions described herein can be directed to a system. The system can include one or more processors coupled with memory. The one or more processors can identify queries received from one or more computing devices over a time interval. The one or more processors can provide a first prompt to one or more generative artificial intelligence models. The first prompt can cause the one or more generative artificial intelligence models to generate a first plurality of categories at a first level in a hierarchical data structure. The one or more processors can evaluate, via the one or more generative artificial intelligence models, the first plurality of categories at the first level using taxonomy criteria and the queries. The one or more processors can modify the first plurality of categories responsive to the evaluation. The one or more processors can provide a second prompt to the one or more generative artificial intelligence models. The second prompt can cause the one or more generative AI models to generate, for each of the first plurality of categories, a second plurality of categories at a second level in the hierarchical tree structure. The one or more processors can construct a knowledge graph data structure linking the first plurality of categories with the corresponding second plurality of categories.

An aspect of the technical solutions described herein can be directed to a method. The method can be performed by one or more processors, coupled with memory. The method can include the one or more processors identifying queries received from one or more computing devices over a time interval. The method can include the one or more processors providing a first prompt to one or more generative artificial intelligence models. The first prompt can cause the one or more generative artificial intelligence models to generate a first plurality of categories at a first level in a hierarchical data structure. The method can include the one or more processors evaluating, via the one or more generative artificial intelligence models, the first plurality of categories at the first level using taxonomy criteria and the queries. The method can include the one or more processors modifying the first plurality of categories responsive to the evaluation. The method can include the one or more processors providing a second prompt to the one or more generative artificial intelligence models. The second prompt can cause the one or more generative AI models to generate, for each of the first plurality of categories, a second plurality of categories at a second level in the hierarchical tree structure. The method can include the one or more processors constructing a knowledge graph data structure linking the first plurality of categories with the corresponding second plurality of categories.

An aspect of the technical solutions described herein can be directed to a non-transitory computer-readable medium that stores processor-executable instructions that, when executed by one or more processors, cause the one or more processors to identify queries received from one or more computing devices over a time interval. The instructions can cause the one or more processors to provide a first prompt to one or more generative artificial intelligence models. The first prompt can cause the one or more generative artificial intelligence models to generate a first plurality of categories at a first level in a hierarchical data structure. The instructions can cause the one or more processors to evaluate, via the one or more generative artificial intelligence models, the first plurality of categories at the first level using taxonomy criteria and the queries. The instructions can cause the one or more processors to modify the first plurality of categories responsive to the evaluation. The instruction can cause the one or more processors to provide a second prompt to the one or more generative artificial intelligence models. The second prompt can cause the one or more generative AI models to generate, for each of the first plurality of categories, a second plurality of categories at a second level in the hierarchical tree structure. The instructions can cause the one or more processors to construct a knowledge graph data structure linking the first plurality of categories with the corresponding second plurality of categories.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

Aspects of the present technical solutions are described in the detailed description which follows, in reference to the noted plurality of drawings by way of non-limiting examples of exemplary embodiments of the present description. The accompanying drawings are not intended to be drawn to scale. Like reference numbers and designations in the various drawings indicate like elements. For purposes of clarity, not every component may be labeled in every drawing.

FIG. 1 is an illustrative example of a system to construct a knowledge graph using a generative artificial intelligence model.

FIG. 2 is an illustrative example of a method of constructing a knowledge graph using a generative artificial intelligence model.

FIG. 3 is an illustrative example of a prompt for constructing a knowledge graph using a generative artificial intelligence model.

FIG. 4 is an illustrative example of taxonomy criteria used to evaluate output from a generative artificial intelligence model used to construct a knowledge graph.

FIG. 5 is an illustrative example of a prompt for evaluating the output of a generative artificial intelligence model used to construct a knowledge graph.

FIG. 6 is an illustrative example of a prompt or an output evaluation from a generative artificial intelligence model.

FIG. 7 is an illustrative example of a prompt for modifying a taxonomy.

FIG. 8A-8C are illustrative examples of a method of constructing a knowledge graph using a generative artificial intelligence model.

FIG. 9 illustrates a block diagram of an example computing system for implementing the embodiments of the present solution, including, for example, the system depicted in FIG. 1 and FIG. 10, the method depicted in FIGS. 2 and 8, and the graphical user interfaces depicted in FIGS. 3, 4, 5, 6 and 7.

FIG. 10 illustrates a diagram of an example system for determining or analyzing queries, taxonomy creation and classification and phrase understanding.

FIG. 11 illustrates an example of a method of generating an example knowledge graph using generative artificial intelligence modeling.

### DETAILED DESCRIPTION

Below are detailed descriptions of various concepts related to, and approaches, methods, apparatuses, and systems for implementing the various techniques described herein. The various concepts introduced above and discussed in greater detail below may be implemented in any of numerous ways, as the described concepts are not limited to any particular manner of implementation. Examples of specific implementations and applications are provided primarily for illustrative purposes.

Aspects of technical solutions described herein are directed to construction and management of a multi-level intent ontology, represented as a knowledge graph, using generative artificial intelligence. When servicing incoming user queries using automated systems, technical solutions can utilize knowledge graph data structures for response generation. For example, the data processing system can utilize a knowledge graph data structure to classify queries input from remote client computing devices to generate query responses based at least in part on the ontology classifications. However, due to the increasing variety of queries, as well as different types and formats of knowledge materials, and increasingly complex or changing configurations of response generation techniques, it can be technically challenging to efficiently and reliably generate and manage a knowledge graph tree structure. This can cause incorrect or erroneous classification of the user queries, leading to erroneous processing of the queries.

To address these and other technical challenges, the technical solutions described herein can use generative artificial intelligence to construct and manage automatically, from unstructured data, a multi-level knowledge graph data structure to use for generating query responses. To do so, the technical solutions described herein can access a data repository storing historical queries that were provided or input by the client devices. These historical queries can be stored in an unstructured manner (e.g., the raw queries may not be categorized). The technology can provide prompts designed and constructed to cause a generative artificial intelligence model to identify categories for the queries using a top-down hierarchical approach. The top-down hierarchical approach can include, for example, first identifying categories at a first, or a broad level, and then iteratively identifying sub-categories for each category in the first level. The technology can generate additional sub-categories at any level of granularity, including, for example, two levels, three levels, four levels, 5 levels or more. Prior to iterating to a sub-category level, the technology can use a generative artificial intelligence based evaluator to evaluate the generated categories using taxonomy criteria. In the event the evaluator identifies errors (e.g., inaccurate, insufficiently granular, unnecessary or excessive categories), the technology can modify the taxonomy. The technical solutions can therefore iteratively evaluate and modify the categories at a given level prior to progressing to the next sub-level, thereby continuously improving the multi-level knowledge graph data structure.

In some implementations, the solutions provide a computing environment for generating knowledge graphs that link user inputs to knowledge gathered from question-and-answer pairs. The solutions can include digital platforms that can process natural language queries from users in a variety of contexts, such as customer service interactions, enterprise resource management, or information retrieval systems. In such implementations, user queries can be varied widely in structure and intent, as well as span a broad range of topics. Computing systems can use structured data representations, such as ontologies or knowledge graphs, to organize information and facilitate the retrieval of relevant responses to user queries. These systems can incorporate repositories of frequently asked questions, intent taxonomics, and other knowledge resources to support query understanding and response generation.

While mapping user queries to relevant information resources can be implemented in some solutions, technical challenges can occur as diversity and volume of user expressions increase. Systems using manually curated taxonomies or static mappings between queries and knowledge sources can consume a significant amount of computational resources, energy and manual effort and also become inconsistent or outdated as user preferences evolve. Ambiguous queries, follow-up questions, and multi-intent utterances can further degrade the reliability as the process of accurately interpreting user input can become increasingly challenging. Such systems can also lack mechanisms for analyzing user query patterns or for scaling intent understanding to new modalities, such as subtle, contextual, or unspoken utterances or actions.

The techniques described herein can address these technical challenges by providing a system that can transform unstructured user queries into organized, actionable insights using an intent ontology represented as a multi-level knowledge graph comprising multiple categories and sub-categories. The generative artificial intelligence models can automatically generate a multi-level intent ontology that organizes or groups intent topics and sub-topics based on unstructured user queries, logs or documents. The system can link user queries to knowledge contained within question-and-answer pairs by using intent categorization, intent classification, and intent analytics. The techniques described herein can further provide mechanisms for analyzing the structure and frequency of user queries, disambiguating follow-up questions, and supporting data-driven decision making.

The system can use intent ontology management features to organize unstructured user queries into a hierarchical structure of intent topics. Intent classifier features can map user questions to intent topics in real time, such that the system can dynamically route queries to appropriate answers in a frequently asked questions repository. Intent analytics features can analyze user query patterns and trends, such that the system can provide visibility into user preferences and inform product development priorities. The system can further support the extension of intent understanding to additional modalities, such as unspoken utterances or actions, by updating the ontology and classification framework as new data sources become available.

The techniques described herein can reduce errors, while conserving computational resources and energy by automating the generation and maintenance of intent ontologies using generative artificial intelligence models. The system can curate taxonomies and improve the consistency and scalability of query understanding across multiple channels and data types. By analyzing user query patterns and supporting dynamic intent classification, the solutions described herein can improve the accuracy and relevance of responses to user queries. The solutions can further support the prioritization of product development based on actual user preferences. The solutions can also allow for the extension of intent understanding to new modalities, such as understanding of contextual, subtle or unspoken utterances or actions, thus providing a flexible and adaptive framework for knowledge graph construction and query understanding.

Thus, aspects of the technical solutions disclosed herein can automatically (e.g., fully automated) generate a knowledge graph data structure with a taxonomy or ontology at various levels of granularity. The technology can mitigate, minimize, prevent, or otherwise reduce hallucinations from the generative AI by using historical queries and a taxonomy evaluator and modifier. Further, the technical solutions described herein can avoid having to apply a deduplication process due to the top-down category generation approach.

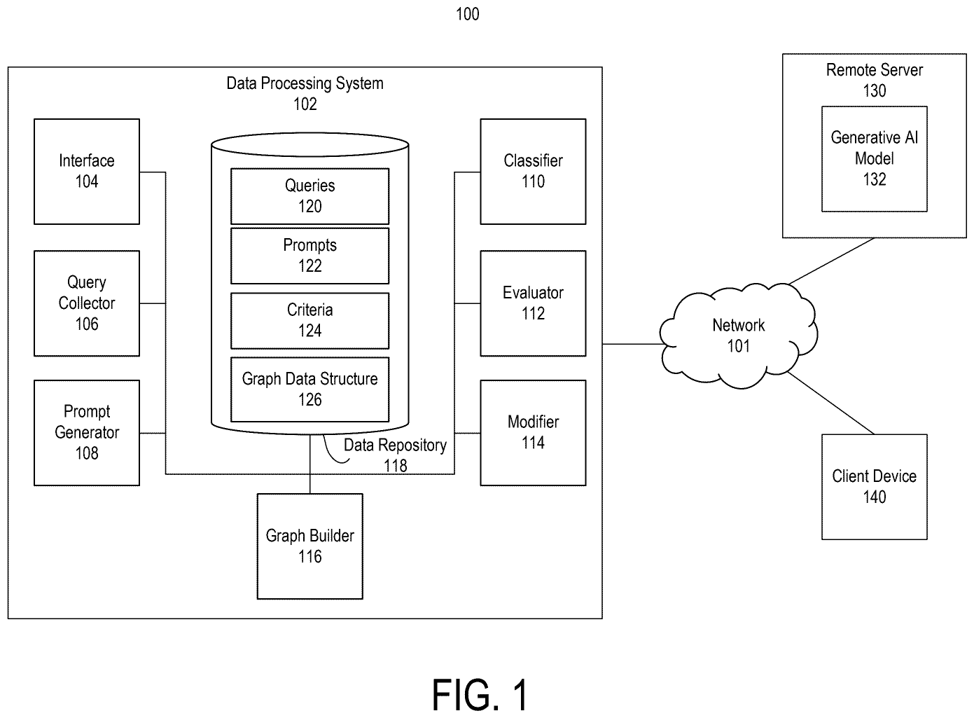

FIG. 1 is an illustrative example system 100 to construct a knowledge graph using one or more generative artificial intelligence models. The system 100 can include a data processing system 102. The data processing system 102 can access, communicate with, or otherwise interface with a remote server 130 via a network 101. The data processing system 102 can access, communicate with, or otherwise interface with a client device 140 via a network 101. The client device 140 can include or refer to any type of computing device, including, for example, a desktop computer, laptop computer, mobile computing device, tablet computing device, mobile telecommunications device, smartphone, wearable device, or digital assistant device.

The data processing system 102 can include at least one interface 104 designed, constructed and operational to facilitate communications via network 101, provide a graphical user interface or other user interface for display via client device 140, or facilitate communications between components of the data processing system 102. The data processing system 102 can include at least one query collector 106 designed, constructed and operational to receive, access, aggregate, or otherwise identify queries input by client devices. The data processing system 102 can include at least one prompt generator 108 designed, constructed and operational to generate prompt for input to one or more generative artificial intelligence models to cause the generative artificial intelligence models to generate an output. The data processing system 102 can include at least one classifier 110 designed, constructed and operational to generate categories using the prompt. The data processing system 102 can include at least one evaluator 112 designed, constructed and operational to evaluate the categories output or provided by the classifier 110. The data processing system 102 can include at least one modifier 114 designed, constructed and operational to modify, adjust or otherwise change the categories. The data processing system 102 can include at least one graph builder 116 designed, constructed and operational to construct a knowledge graph data structure using the categories generated by the one or more generative artificial intelligence models.

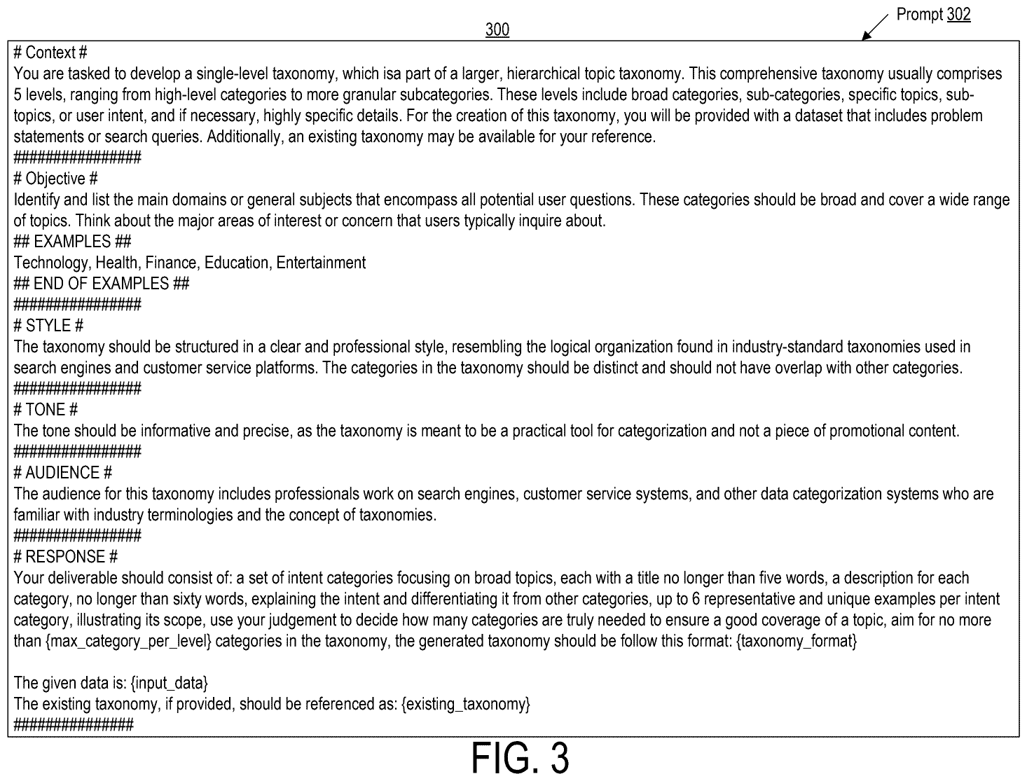

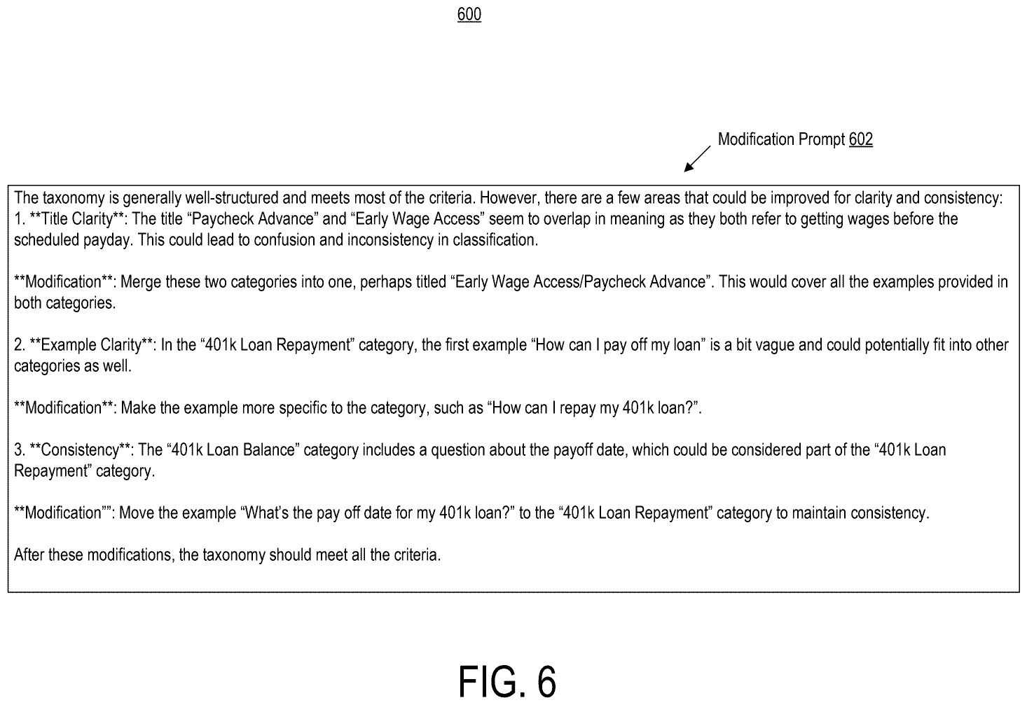

The data processing system 102 can include, access, or otherwise interface with at least one data repository 118. The data repository 118 can include or refer to one or more databases, data structures, files, or file systems. The data repository 118 can be stored in memory or other storage of the data processing system 102, or accessed by the data processing system 102 via network 101. The data repository 118 can include, store, or maintain queries 120, such as historical queries received from client devices 140. The data repository 118 can include, store, or maintain prompts 122, such as prompts illustrated in FIG. 3, 5, or 7. The data repository 118 can include, store, or maintain criteria, such as criteria illustrated in FIG. 6.

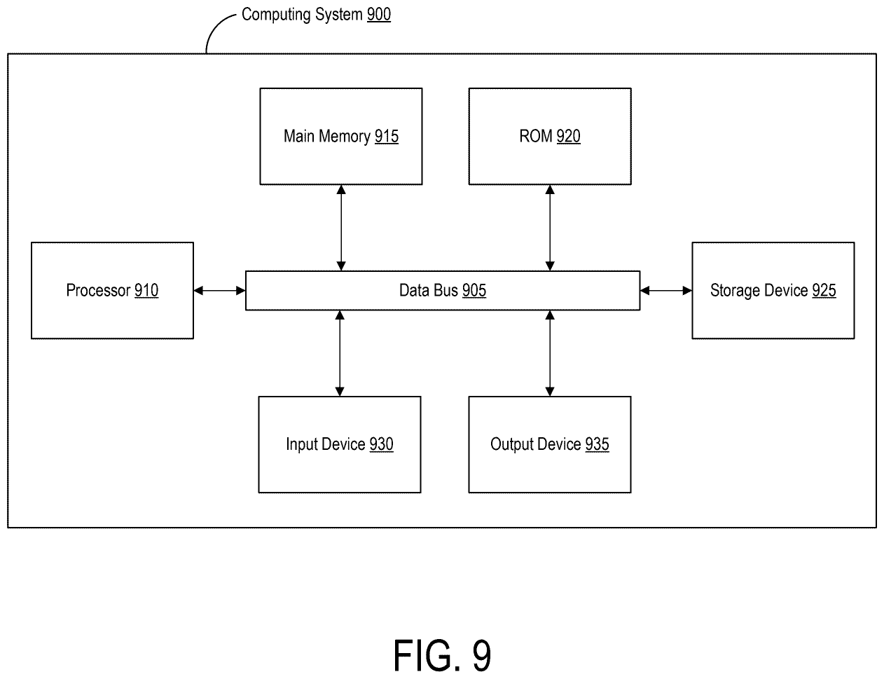

One or more component depicted in FIG. 1 can include one or more system, component, or functionality depicted in FIG. 9. Network 101 can include one or more types of networks that can be used for communication between. Network 101 can include the Internet or one or more Local Area Networks (LANs), which can be used within a limited geographical area, such as an office or building, and Wide Area Networks (WANs), which span larger distances and can connect devices across cities or countries. Network 101 can include one or more Metropolitan Area Networks (MANs) which can be utilized to cover a city or metropolitan area. Network 101 can support internet-based connections, using protocols like TCP/IP, and enable access to cloud-based data processing systems. Network 101 can include or support wireless networks, such as Wi-Fi and cellular networks, as well as Virtual Private Networks (VPNs) which can provide security to public networks. Network 101 can include or utilize Intranets (e.g., private networks within an organization) facilitating internal communications.

The remote server 130 can refer to or include a cloud computing environment. The remote server 130 can provide a software-as-a-service computing architecture. The remote server 130 can provide one or more generative artificial intelligence (“AI”) models 132. In some cases, the data processing system 102 can include the generative AI model 132. In some cases, the remote server 130 can train or create the generative AI model 132, and deploy the generative AI model 132 on the data processing system 102. A generative AI model 132 can refer to or include a machine learning model or other artificial intelligence-based model that is trained on data, validated, and deployed to make inferences or generate new output based on input. The generative AI model 132 can be trained using various techniques, processes, or architectures.

The generative AI model 132 can be built using deep learning techniques, such as neural networks, and can be trained on large amounts of data. The generative AI model 132 can be designed, constructed or include a transformer architecture with one or more of a self-attention mechanism (e.g., allowing the model to weigh the importance of different words or tokens in a sentence when encoding a word at a particular position), positional encoding, encoder and decoder (multiple layers containing multi-head self-attention mechanisms and feedforward neural networks). For example, each layer in the encoder and decoder can include a fully connected feed-forward network, applied independently to each position. The data processing system 102 or remote server 130 can apply layer normalization to the output of the attention and feed-forward sub-layers to stabilize and improve the speed with which the generative AI model 132 is trained. The data processing system 102 or remote server 130 can leverage any residual connections to facilitate preserving gradients during backpropagation, thereby aiding in the training of the deep networks. Transformer architecture can include, for example, a generative pre-trained transformer, a bidirectional encoder representations from transformers, transformer-XL (e.g., using recurrence to capture longer-term dependencies beyond a fixed-length context window), text-to-text transfer transformer.

The generative AI model 132 can be trained (e.g., by a model training function) using any text-based dataset by converting the text data from the input dataset documents into numerical representations (e.g., embeddings) of the chunks of those documents. These embeddings can capture the semantic meaning of words, paragraphs, pages or sentences, depending on the size and type of chunks of dataset documents are parsed into. Embeddings can be used to represent and organize the dataset documents within a high-dimensional space (e.g., embedding space), where similar documents or concepts are located closer together. Embedding space can include a multi-dimensional vector space where each data point is represented by an embedding.

Through training, the generative AI model 132 can learn, or adjust its understanding of mapping the embeddings to particular issues (e.g., prompts related to identifying categories for queries used to construct a knowledge graph data structure, or evaluating categories identified by a generative AI model 132), by adjusting its internal parameters. Internal parameters can include numerical values of the generative AI model 132 that the model learns and adjusts during training to optimize its performance and make more accurate predictions. Such training can include iteratively presenting the various data chunks or documents of the dataset (e.g., or their chunks, embeddings) to the generative AI model 132, comparing its predictions with the known correct answers, and updating the model's parameters to minimize the prediction errors. By learning from the embeddings of the dataset data chunks, the generative AI model 132 can gain the ability to generalize its knowledge and make accurate predictions or provide relevant insights when presented with prompts 122.

The generative AI model 132 can include any ML or AI model or a system that can learn from a dataset to generate new content (e.g., text or images) that resembles a distribution of the training dataset. A distribution of a dataset can include an underlying probability distribution representing the patterns and characteristics of the data used to train a generative AI model 132. For example, a training data distribution can represent statistical properties of a text data (e.g., text corpus), such as the frequency of words, the co-occurrence of terms, and the overall structure of the language used in the training dataset. The generative AI model 132 can include the functionality to utilize such a probability distribution of patterns and characteristics to generate new responses (e.g., predictions) that were not present in the dataset. The generative AI model 132 can generate, responsive to the prompt, output indications that can include categories or evaluations.

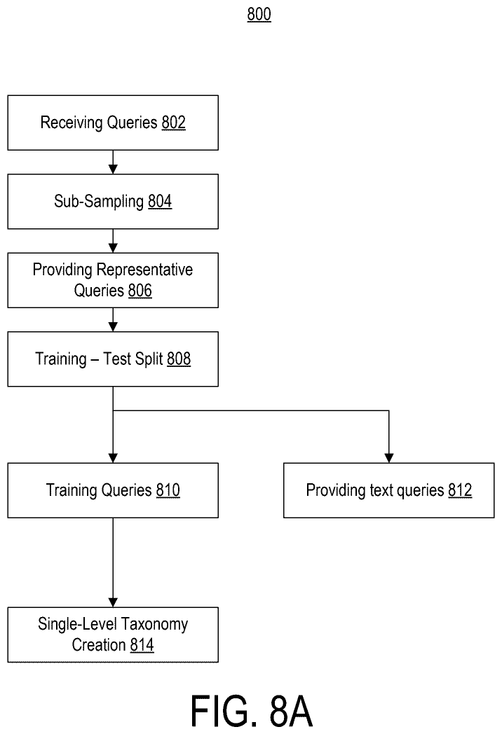

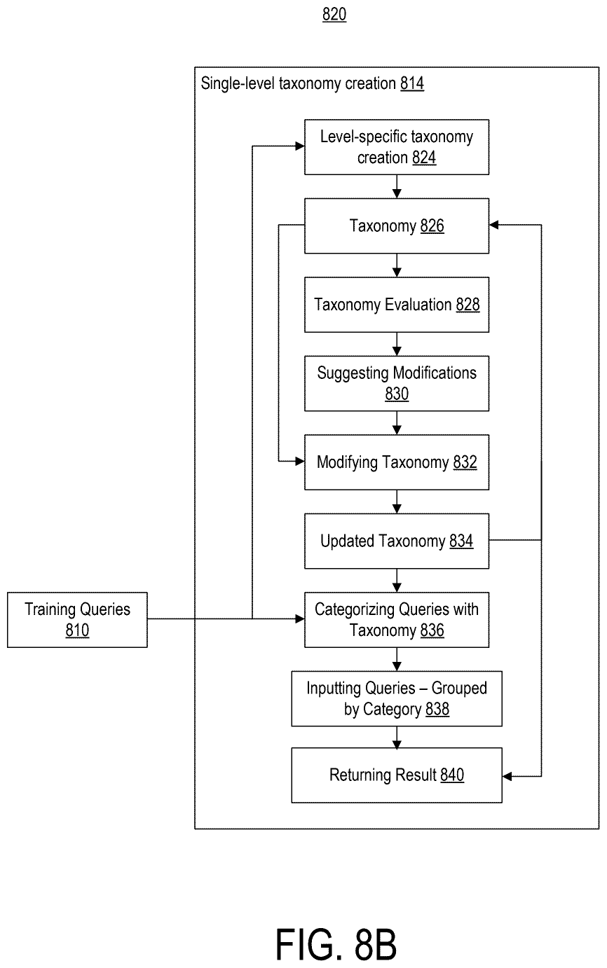

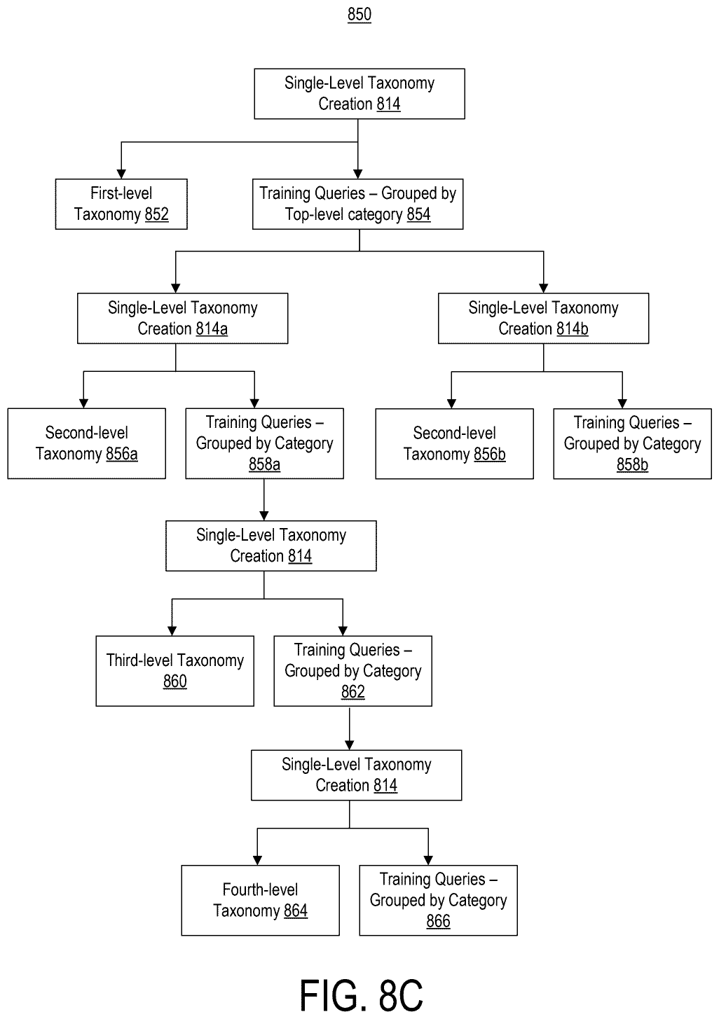

The data processing system 102 can include at least one query collector 106 designed, constructed and operational to receive, access, aggregate, or otherwise identify queries input by client devices. The query collector 106 can identify a plurality of items of unstructured data. The unstructured data can include data from various user queries, logs, documents, guidelines, regulations or other textual or media (e.g., video or graphical) sources. The query collector 106 can identify queries received from one or more computing devices over a time interval. The time interval can be the last 24 hours, 48 hours, 72 hours, 1 week, 30 days, 1 month, 60 days, 90 days, 6 months, a year, or other time interval. The query collector 106 can subsample queries to reduce computational resource utilization in a manner to maintain relevant information (e.g., as depicted in FIG. 8).

The queries can be unstructured user queries. The format of the queries can include a list of question strings. The data processing system 102 can process various formats of queries, including, for example, JSON, list, CSV files, or spark tables. The query collector 106 can access queries 120 stored in data repository 118. Example queries 120 can include: “Do employee's get 14 days paid vacation?”, “What is policy assignment on a time off request?”, “If I'm sick could I still attend work”, “where do I complain about unpaid missed breaks?”, or “need to review new handbook changes.”

The data processing system 102 can include at least one prompt generator 108 designed, constructed and operational to generate prompt for input to one or more generative artificial intelligence models to cause the generative artificial intelligence models to generate an output. For example, the prompt generator 108 can provide, for one or more generative artificial intelligence models 132, a first prompt to cause the one or more generative artificial intelligence models 132 to output a plurality of first level categories of a hierarchical data structure for the plurality of items of unstructured data.

For instance, the prompt generator 108 can provide a first prompt to one or more generative artificial intelligence models to cause the one or more generative artificial intelligence models to generate a first plurality of categories at a first level in a hierarchical data structure. The hierarchical data structure can include levels that are top-down, such that the first level can be a top level or a broadest level or category or topic. Subsequent levels can increase in granularity relative to a higher or top level. For example, a second level can correspond to sub-topics of the first level. In some implementations, the prompt generator 108 can provide a first prompt that includes a representation of at least one example taxonomy or an example knowledge graph data structure. For example, the prompt generator 108 can provide a prompt that includes a sample taxonomy describing domains such as payroll, benefits, or time off, among others.

While generating additional levels of categories, the prompt generator 108 can generate or provide prompts with specified instructions tailored for generating sub-categories withing a particular lower level category. For instance, the prompt generator 108 can provide, responsive to the evaluation, for the one or more generative artificial intelligence models 132, a second prompt to cause the one or more generative artificial intelligence models 132 to output a plurality of second level categories of the hierarchical data structure for each first level category of the plurality of first level categories. As another example, the prompt generator 108 can generate a prompt instructing the generative artificial intelligence models 132 to further subdivide a selected second level category into third level sub-categories based on semantic distinctions identified within the data assigned to that second level category. For instance, the second level sub-categories can be sub-categories within a category of a first level category, and third-level sub-categories can be sub-categories within a second level sub-category of the plurality of second level sub-categories.

The prompt generator 108 can generate prompts for next level categories following evaluations, validations or modifications completed in preceding level categories. For example, the modifier 114 can modify at least a first level category of the plurality of first level categories in response to the evaluation, such that the modified first level category satisfies one or more taxonomy criteria. For example, the prompt generator 108 can provide a second prompt for the one or more generative artificial intelligence models 132 in response to confirmation that each first level category of the plurality of first level categories satisfies the one or more taxonomy criteria.

For example, the modifier 114 can receive a first level category membership score for each first level category and can compare the first level category membership score to a first threshold value. The modifier 114 can determine, based on the comparison, whether the first level category membership score for a particular first level category is below the first threshold value. In response, the modifier 114 can modify the respective first level category. In some implementations, the modifier 114 can receive a second level category membership score for each second level category and can compare the second level category membership score to a second threshold value. The modifier 114 can determine, based on the comparison, whether the second level category membership score for a particular second level category is below the second threshold value. In response, the modifier 114 can modify the respective second level category. For example, the modifier 114 can perform the modification of the respective first level category or the second level category by merging the respective category with a related category, splitting the respective category into two or more categories, removing the respective category, reassigning one or more items to a different category, or assigning a new label to the respective category, among others.

The historical queries 120 can be added as part of the prompt or instruction that the data processing system 102 sends to the generative AI model 132 for taxonomy generation. An example first prompt is depicted in FIG. 3. The first prompt can include a placeholder or “input_data” for the historical queries 120. Besides taking the queries 120 as input, generative AI model 132 can use, or the data processing system 102 can provide, an existing taxonomy (e.g., graph data structure 126) as a reference for taxonomy creation. Thus, the data processing system 102 can refine, expand, or otherwise improve upon an existing taxonomy by integrating insights from new queries. The existing taxonomy may have been previously generated by the data processing system 102, such that the data processing system 102 can improve taxonomies automatically based on a time interval (e.g., periodically, or responsive to an event or condition).

The data processing system 102 can include at least one classifier 110 designed, constructed and operational to generate categories using the prompt. The classifier 110 can utilize or include the generative AI model 132. The classifier 110 can use an application programming interface (“API”) to transmit the generated first prompt to remote server 130 to cause the remote server 130 to input the prompt to the generative AI model 132. The data processing system 102, or classifier 110, can receive output from the generative AI model 132 that indicates categories at a first level of taxonomy.

The classifier 110 can receive, in response to the first prompt and the plurality of items of unstructured data input into the one or more generative artificial intelligence models 132, the plurality of first level categories. Each first level category of the plurality of first level categories can correspond to a respective first level subset of the plurality of items of unstructured data. For example, the classifier 110 can group items such as user queries, chat transcripts, or search logs into broad categories like “payroll,” “benefits,” or “time off.” The first level subset can be grouped according to a semantic similarity operation performed on the plurality of items of unstructured data, such that items with related subject matter are assigned to the same category.

The classifier 110 can receive, for each first level category, the plurality of second level categories. The classifier 110 can receive the plurality of second level categories responsive to the second prompt input into the one or more generative artificial intelligence models 132. Each second level category of the plurality of second level categories can correspond to a respective second level subset of the plurality of items of unstructured data within a corresponding first level subset of the respective first level category. The second level subset can be grouped according to a semantic similarity operation performed on the respective first level subset. For example, the classifier 110 can receive, for a first level category such as “payroll,” a plurality of second level categories such as “direct deposit issues” and “payroll deductions,” where each second level category corresponds to a subset of queries within the “payroll” category that are grouped based on semantic similarity.

The classifier 110 can generate an embedding vector for each item of the plurality of items of unstructured data using machine learning. The classifier 110 can use the embedding vectors to perform a semantic similarity operation. For example, the classifier 110 can group subsets of the plurality of items of unstructured data based on a similarity metric applied to the embedding vectors. For example, the classifier 110 can assign queries related to payroll or benefits, among others, to the same subset based on the similarity of the embedding vectors generated for each query.

For example, the classifier 110 can generate a first layer label for each first level category of the plurality of first level categories based on a subject matter associated with the plurality of items of unstructured data within the corresponding first level subset. The classifier 110 can use the one or more generative artificial intelligence models 132 to generate the first layer label. In some implementations, the classifier 110 can generate a second layer label for each second level category of the plurality of second level categories based on a context of the corresponding first level category to which the second level category belongs, or based on a subset of a subject matter domain that corresponds to the corresponding first level category.

The classifier 110 can use the one or more generative artificial intelligence models 132 to generate the second layer label. In some implementations, the classifier 110 can determine a first level category membership score for each first level category of the plurality of first level categories. The classifier 110 can determine the first level category membership score based on a similarity operation performed between a representative item for the respective first level category and remaining items of unstructured data within the respective first level category. In some implementations, the classifier 110 can determine a second level category membership score for each second level category of the plurality of second level categories. The classifier 110 can determine the second level category membership score based on a similarity operation performed between a representative item for the respective second level category and remaining items of unstructured data within the respective second level category.

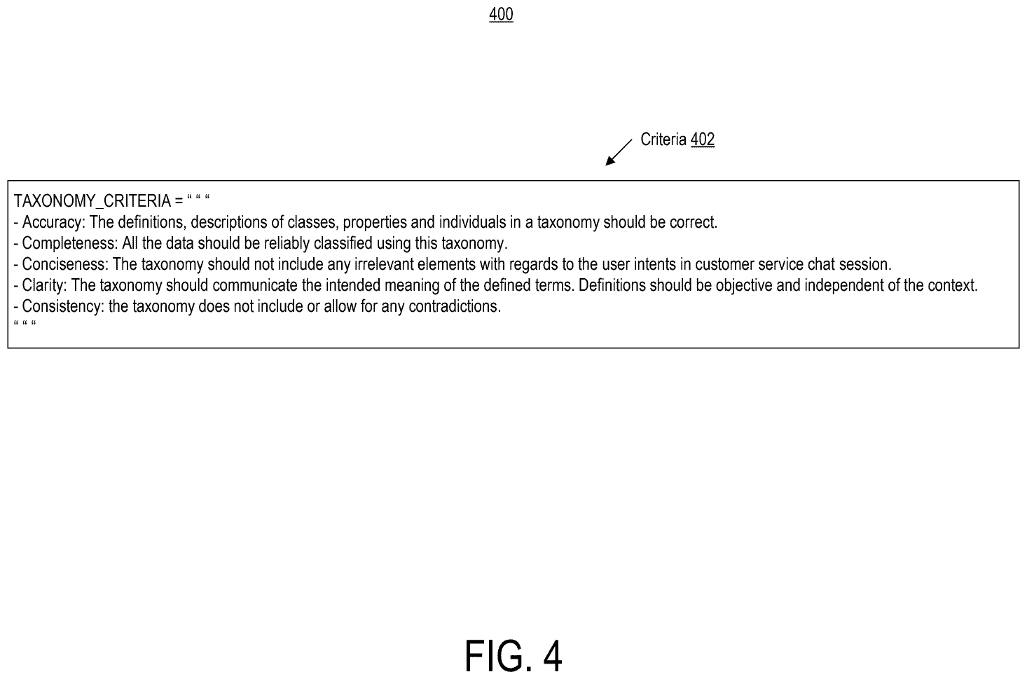

The data processing system 102 can include at least one evaluator 112 designed, constructed and operational to evaluate the categories output or provided by the classifier 110. The evaluator 112 can evaluate, via the one or more generative artificial intelligence models, the first plurality of categories at the first level using taxonomy criteria 124 and the queries. The evaluator 112 can evaluate, via the one or more generative artificial intelligence models 132, each first level category of the plurality of first level categories according to one or more taxonomy criteria for the plurality of first level categories of the hierarchical data structure. The evaluator 112 can utilize an evaluation prompt 502 to evaluate the categories according to taxonomy criteria 124. Example taxonomy criteria 124 is illustrated in FIG. 4. Criteria 124 can include accuracy, completeness, conciseness, clarity, or consistency. Criteria 124 can include or refer to metrics.

The criteria 124 can include any metric, threshold, rule, or evaluative standard used to assess or modify categories generated by the generative artificial intelligence models 132. The criteria 124 can be stored in the data repository 118. The criteria 124 can include at least one of a threshold corresponding to a proportion of the plurality of items assigned to at least one of the first level categories or the second level categories. For example, the threshold can specify a minimum or maximum proportion of items that can be assigned to a given category before the category is accepted or modified. The criteria 124 can include an inter-model agreement score determined from parallel classifications by two or more generative artificial intelligence models 132. For example, the inter-model agreement score can be determined by comparing the outputs of multiple generative artificial intelligence models 132 on the same set of items to determine a level of consensus or disagreement.

The criteria 124 can include a category size threshold corresponding to a number of items grouped in each category of the second level categories. For example, the category size threshold can require that each category at the second level include at least a minimum number of items and may not exceed a maximum number of items. The criteria 124 can include a label clarity threshold corresponding to unambiguity of category labels within a subject matter domain. For example, the label clarity threshold can indicate that each category label be made unambiguous and clearly distinguishable from other category labels within the same subject matter domain. The criteria 124 can include a category overlap threshold corresponding to a limitation of a number of items of the plurality of items that are assigned to more than one category within a hierarchy level. For example, the category overlap threshold can specify that no more than a certain number or proportion of items may be assigned to multiple categories at the same hierarchy level.

The evaluator 112 can apply criteria 124 or metrics to evaluate a level, such as by using level-wise metrics. When performing level-wise evaluation, comprehensiveness metric can refer to whether all the data is reliably classified using this single-level taxonomy. The evaluator 112 can evaluate categories using the comprehensiveness metric by looking at what proportion of instances by assessors (e.g., generative AI model 132 or LLM) end up in the ‘Other’ category. When performing level-wise evaluation, the consistency metric can refer to whether the taxonomy does not include or allow for any contradictions. The evaluator 112 can evaluate categories using the consistency metric by determining how often assessors (e.g., generative AI model 132) encounter difficulty distinguishing between two labels, e.g., the disagreement rate. This can involve analyzing the disagreement rate between two assessors' categorization outcomes.

When performing level-wise evaluation, the accuracy metric can refer to whether the definitions, descriptions of classes, properties, and individuals in a taxonomy are correct. The evaluator 112 can evaluate categories using the accuracy metric by utilizing the same measurement methods as those used for evaluating consistency, but with an emphasis on agreement among multiple assessors. Inaccurate descriptions and definitions can cause confusion, potentially leading to misleading classification outcomes. Consequently, any degradation in the agreement between different assessors could indicate a lack of accuracy.

When performing level-wise evaluation, the conciseness metric can refer to whether the taxonomy includes any irrelevant elements with regards to the user intents and not overly categorize. The evaluator 112 can quantitatively evaluate categories using the conciseness metric by examining the distribution of categorized queries. If a particular category incorporates only a small proportion of queries, then it may not be concise or relevant enough. When performing level-wise evaluation, the clarity metric can refer to whether the taxonomy communicates the intended meaning of the defined terms. Definitions can be objective and independent of the context. The evaluator 112 can evaluate categories using the clarity metric by eliciting from the human assessors how clear the definitions and examples are for them.

The evaluator 112 can use hierarchical metrics to evaluate the taxonomy after multiple levels of categories are generated. When performing hierarchical-wise evaluation of the taxonomy, the relevance metric can refer to whether each subtopic is directly relevant to the super topic. It can address a specific aspect, feature, or area of the super topic. The evaluator 112 can evaluate categories using the relevance metric by eliciting from the human assessors how relevant the sub-topics are to the super topic.

When performing hierarchical-wise evaluation of the taxonomy, a balance metric can refer to whether subtopics are balanced in terms of their scope and depth. No one subtopic should dominate the discussion or content of the super topic. The evaluator 112 can evaluate categories using the balance metric by eliciting from the human assessors if the sub-topics are of the same complexity. When performing hierarchical-wise evaluation of the taxonomy, a clarity metric can refer to whether the super topic is defined and named in a way that makes their content and relationship to the sub-topics clear. The evaluator 112 can evaluate categories using the clarity metric by an exact match, and determining the ratio that the sub-topics are included as an example in the super topic's description.

When performing hierarchical-wise evaluation of the taxonomy, a completeness metric can refer to checking if the super (e.g., lower level or a preceding) class category is adequately represented by its subcategories. The subcategories can cover any aspects of the super class category, such as any of sub-aspects or topics within a category. The evaluator 112 can evaluate categories using the completeness metric by determining what proportion of instances by assessors (e.g., LLM) end up in the ‘Other’ category.

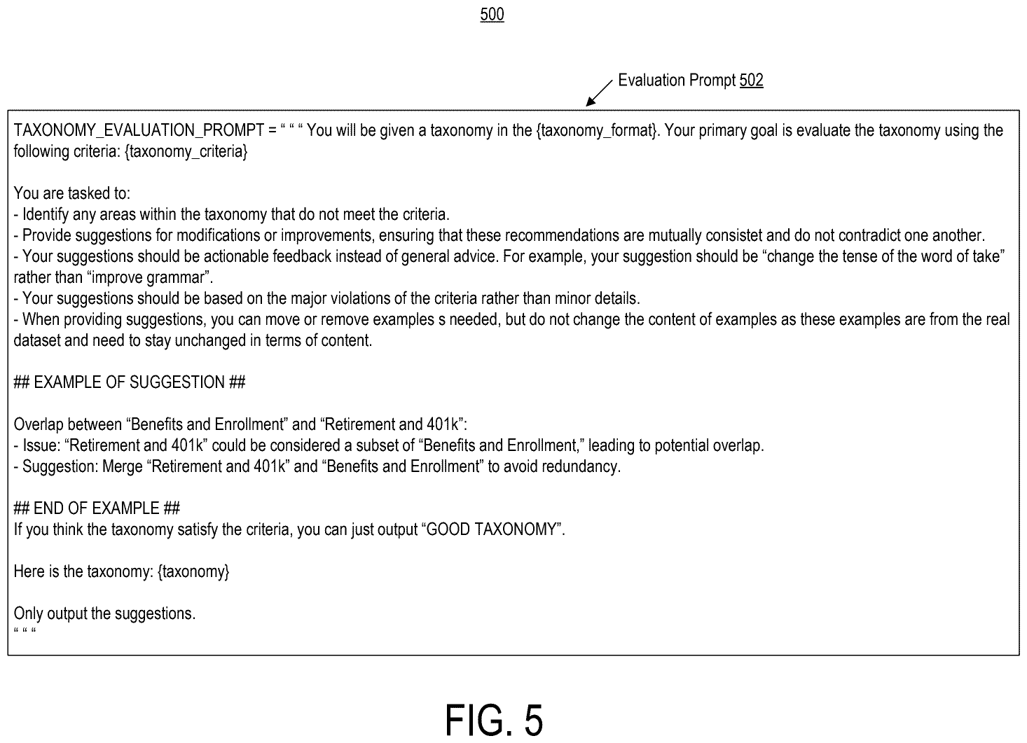

The evaluator 112 can include a generative AI model 132, such as a large language model (“LLM”), that can assess a given taxonomy based on the criteria or metrics. An example prompt used by the evaluator 112 is depicted in FIG. 5. The prompt can include a placeholder or “taxonomy_criteria” to put in the criteria 124. The evaluator 112 can evaluate the categories using some or all of the criteria 124 (which includes the level-wise and hierarchical-wise metrics). The “taxonomy_format” can be used to inform the LLM what format the taxonomy being evaluated is in, which facilitate enhancing the interpretability of the input taxonomy.

The output of the evaluator 112 can be a textual statement that indicates if the taxonomy satisfies the criteria 124 (e.g., good to return), or if further improvement of the taxonomy is desired, requested, or possible. The evaluator 112, to improve the taxonomy, can indicate how a particular criteria 124 was violated (or not satisfied), and suggest a modification to the taxonomy to improve the taxonomy such that the criteria is satisfied. An example output of the evaluator 112 is depicted in FIG. 6.

The evaluator 112 can use a different generative AI model 132 relative to the generative AI model 132 that received the first prompt with the user queries to create the categories. The evaluator 112 can use an LLM stored on the data processing system 102. The LLM used by the evaluator 112 can vary in structure relative to the LLM used by the classifier 110. The LLMs can vary in their architecture, training data, training methods (e.g., pre-training SFT or RLHF), parameter weights. The LLM employed by the evaluator 112 to evaluate the taxonomy based on the criteria can be configured to leverage the LLM's reasoning and language comprehension capabilities.

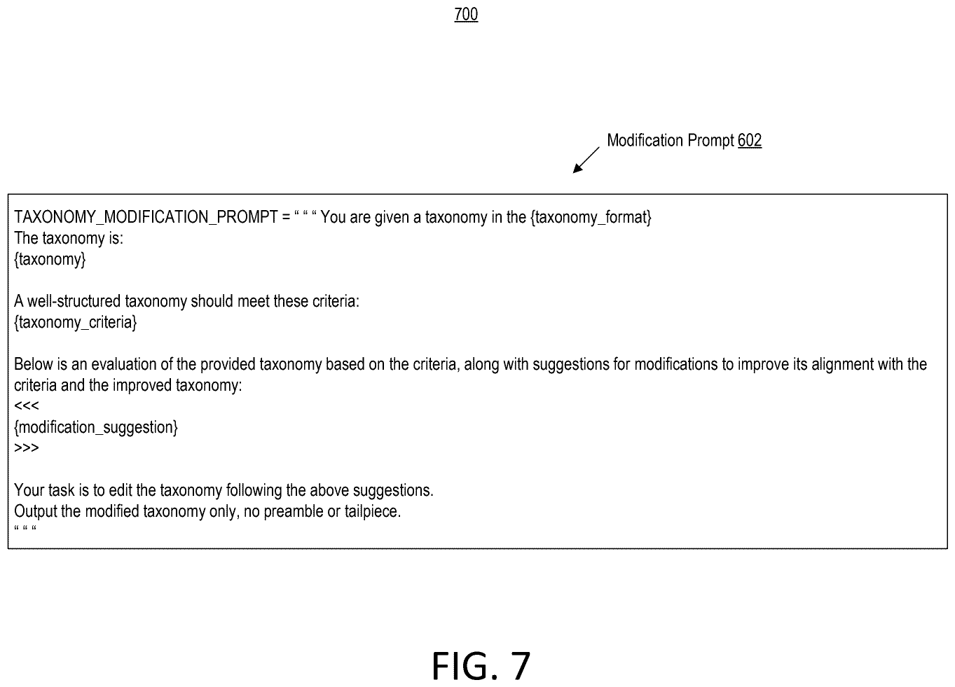

The data processing system 102 can include at least one modifier 114 designed, constructed and operational to modify, adjust or otherwise change the categories. The modifier 114 can modify the first plurality of categories responsive to the evaluation. The modifier 114 can use a different LLM relative to the evaluator 112 or classifier 110. The modifier 114 can generate or use a prompt that includes the taxonomy and the suggested modification provided by the evaluator 112. An example prompt used by the modifier 114 is depicted in FIG. 7. The output of the modifier 114 can include the modified taxonomy.

The data processing system 102 can re-evaluate the modified taxonomy to determine whether the modified taxonomy satisfies the criteria. The data processing system 102 can iterate through modification and evaluation until the modified taxonomy satisfies the criteria. In some cases, the evaluator can include a universal evaluator that is applied to all levels, or the evaluator can be customized or tailored for each level to more precisely determine the coherence of each taxonomy with its corresponding super-category. In some cases, the data processing system 102 can perform parallel processing at each sub-category to improve efficiencies and reduce delays or computing latencies in constructing the knowledge graph data structure.

The data processing system 102 can include at least one graph builder 116 designed, constructed and operational to construct a knowledge graph data structure using the categories generated by the one or more generative artificial intelligence models. The graph builder 116 can build a knowledge graph data structure or tree data structure using the results from the various components of the data processing system 102. The graph builder 116 can build the knowledge graph by compiling the results and integrating the results according to the principle of attaching sub-category taxonomies as child nodes to their respective super-categories. The constructed knowledge graph can be validated, customized, or adjusted for improvements. Thus, the data processing system 102 can fully automatically construct a knowledge graph data structure based on user queries.

The graph builder 116 can construct, using the one or more generative artificial intelligence models 132, a knowledge graph data structure 126. The knowledge graph data structure 126 can link each of the plurality of first level categories and their respective first level subsets with second level categories and respective second level subsets within the respective first level subset. The knowledge graph data structure 126 can relate each of the plurality of items of unstructured data with a corresponding first level category of the plurality of first level categories and a corresponding second level category of the plurality of second level categories according to the hierarchical data structure. For example, the graph builder 116 can link a first level category such as “payroll” and its subset of queries with a second level category such as “direct deposit issues” and its respective subset, so that a query about a missed paycheck is related to both “payroll” and “direct deposit issues” in the knowledge graph data structure 126.

In some implementations, the interface 104 can receive a query from the client device 140, where the query can include content corresponding to a topic. In response, the classifier 110 can determine, based on the content of the query and the knowledge graph data structure 126, a first level category from the plurality of first level categories and a second level category from the plurality of second level categories within the first level category. The classifier 110 can select, based on the second level category, an item from the plurality of items of unstructured data that corresponds to the topic. The interface 104 can provide, to the client device 140 in response to the query, a response based on the item.

The data processing system 102 can generate additional levels of hierarchical categorization by prompting the generative artificial intelligence models 132 to output further subcategories. In some implementations, the prompt generator 108 can provide a third prompt for at least one second level category of the plurality of second level categories, such that the one or more generative artificial intelligence models 132 can output a plurality of third level categories for the respective second level category. In some implementations, the classifier 110 can receive, for each of the second level categories provided to the one or more generative artificial intelligence models 132, a plurality of third level categories. Each third level category can correspond to a third level subset of items of unstructured data within a respective second level subset. The third level subset can be grouped according to a semantic similarity operation performed on the respective second level subset. In some implementations, the classifier 110 can generate, using the one or more generative artificial intelligence models 132, a third layer label for each third level category based on context associated with the respective second level category or domain associated with the respective second level category.

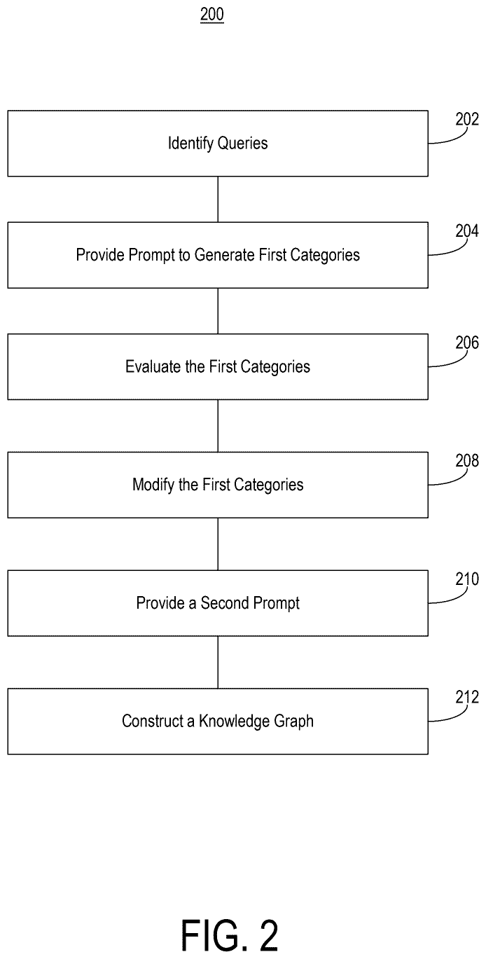

FIG. 2 is an illustrative example of a method 200 of an embedded resource management platform. The method 200 can be performed by one or more processors. The method 200 can be performed by one or more system or component depicted in FIG. 1 or FIG. 9. At ACT 202, the method 200 can include the one or more processors identifying queries received from one or more computing devices over a time interval.

At ACT 204, the method 200 can include the one or more processors providing a first prompt to one or more generative artificial intelligence models. The first prompt can cause the one or more generative artificial intelligence models to generate a first plurality of categories at a first level in a hierarchical data structure. The method can include the query collector implemented via one or more processors coupled with memory, identifying a plurality of items of unstructured data. The items of unstructured data can include, for example, user queries collected from chat transcripts, search logs, or customer service tickets, guidelines, specifications, as well as other forms of unstructured textual input such as feedback forms or email correspondence.

Once the unstructured data is identified, the method can further include providing, by a prompt generator implemented via the one or more processors, a first prompt to one or more generative artificial intelligence models. This first prompt can be configured to cause the generative artificial intelligence models to output a plurality of first level categories that form the initial layer of a hierarchical data structure for organizing the plurality of items. The first prompt can include a representation of at least one example taxonomy or an example knowledge graph data structure.

For instance, the prompt can reference a sample taxonomy that organizes topics into domains such as payroll, benefits, or time off, or can present an example knowledge graph that links intent categories to representative user questions. As another example, the prompt can include a hierarchical structure illustrating categories and sub-categories relevant to a particular business domain, such as a taxonomy that distinguishes between employment verification, payroll inquiries, and leave requests. By including such examples, the generative artificial intelligence models can be guided to produce first level categories that are aligned with established organizational frameworks or domain-specific requirements. This approach enables the system to efficiently bootstrap the taxonomy generation process and ensures that the resulting hierarchical data structure is both comprehensive and contextually relevant.

At ACT 206, the method 200 can include the one or more processors evaluating, via the one or more generative artificial intelligence models, the first plurality of categories at the first level using taxonomy criteria and the queries. In response to the first prompt and the input of the plurality of items into the one or more generative artificial intelligence models, the one or more processors can receive a plurality of first level categories. Each first level category can correspond to a respective first level subset of the plurality of items, where the first level subset is grouped based on a semantic similarity operation applied to the plurality of items. For example, when processing a collection of user queries related to employee benefits, payroll, and time off, the generative artificial intelligence models can output first level categories such as “benefits,” “payroll,” and “time off,” with each category grouping together queries that share similar semantic content, such as all questions about paid leave being assigned to the “time off” category.

The evaluator of the data processing system can evaluate each first level category of the plurality of first level categories by using the one or more generative artificial intelligence models. The evaluation can be performed according to one or more taxonomy criteria for the plurality of first level categories of the hierarchical data structure. The taxonomy criteria can include accuracy, completeness, conciseness, clarity, or consistency, among others. The one or more processors can apply the taxonomy criteria to each first level category to determine whether the categories meet the specified standards. For example, the one or more processors can use the one or more generative artificial intelligence models to determine whether a first level category such as “payroll” includes a sufficient number of queries to satisfy a completeness criterion, or whether the label of a first level category such as “benefits” is unambiguous within the subject matter domain to satisfy a clarity criterion.

The method can include the classifier generating an embedding vector for each item of the plurality of items of unstructured data by applying a machine learning operation to the unstructured data. The data processing system can receive the plurality of embedding vectors and can group subsets of the plurality of items based on a similarity metric applied to the embedding vectors during a semantic similarity operation. The similarity metric can include a cosine similarity, a Euclidean distance, or a dot product, among others. For example, the data processing system can generate an embedding vector for each user query in a collection of queries, and can group queries such that queries about payroll, benefits, or time off, among others, are assigned to the same subset based on the similarity of the embedding vectors generated for each query.

The taxonomy criteria used to create the categories can include any combination of individual criteria. For instance, the taxonomy criteria can include at least one of a threshold corresponding to a proportion of the plurality of items assigned to at least one of the first level categories or the second level categories, an inter-model agreement score determined from parallel classifications by two or more generative artificial intelligence models, a category size threshold corresponding to a number of items grouped in each category of the second level categories, a label clarity threshold corresponding to unambiguity of category labels within a subject matter domain, or a category overlap threshold corresponding to a limitation of a number of items of the plurality of items that are assigned to more than one category within a hierarchy level. In some implementations, the taxonomy criteria can be applied by the evaluator to determine whether a generated taxonomy satisfies one or more requirements for accuracy or clarity. For example, the evaluator can compare the proportion of items assigned to a single category to a predetermined threshold, such as determining whether more than fifty percent of the plurality of items are assigned to a single first level category, or can determine whether the same item is assigned to more than one second level category within the same hierarchy level, such that the number of overlapping assignments does not exceed a specified maximum.

At ACT 208, the method 200 can include the one or more processors modifying the first plurality of categories responsive to the evaluation. The method can include modifying, by the one or more processors, responsive to the evaluation, at least a first level category of the plurality of first level categories to satisfy the one or more taxonomy criteria. The method can include comparing each first level category membership score to a first threshold value. For each first level category with a membership score below the first threshold value, the method can modify the respective first level category. The method can compare each second level category membership score to a second threshold value and, for each second level category with a membership score below the second threshold value, modify the respective second level category, The modification of the respective first level category or the second level category can include at least one of: merging the respective category with a related category, splitting the respective category into two or more categories, removing the respective category, reassigning one or more items to a different category, or assigning a new label to the respective category.

At ACT 210, the method 200 can include the one or more processors providing a second prompt to the one or more generative artificial intelligence models. The second prompt can cause the one or more generative AI models to generate, for each of the first plurality of categories, a second plurality of categories at a second level in the hierarchical tree structure. The method can include providing, responsive to the evaluation, for the one or more generative artificial intelligence models, a second prompt to cause the one or more generative artificial intelligence models to output a plurality of second level categories of the hierarchical data structure for each first level category of the plurality of first level categories.

The method can include receiving, for each first level category and responsive to the second prompt input into the one or more generative artificial intelligence models, the plurality of second level categories. Each second level category of the plurality of second level categories can correspond to a respective second level subset of the plurality of items of unstructured data within a corresponding first level subset of the respective first level category. The second level subset can be grouped according to a semantic similarity operation performed on the respective first level subset. The method can modify, responsive to the evaluation, at least a first level category of the plurality of first level categories to satisfy the one or more taxonomy criteria. The method can provide the second prompt for the one or more generative artificial intelligence models, responsive to confirmation that each first level category of the plurality of first level categories satisfies the one or more taxonomy criteria.

The classifier can generate, using the one or more generative artificial intelligence models, a first layer label for each first level category of the plurality of first level categories based on a subject matter associated with the plurality of items of unstructured data within the corresponding first level subset. The classifier can generate, using the one or more generative artificial intelligence models, a second layer label for each second level category of the plurality of second level categories based on a context of the corresponding first level category to which the second level category belongs and a subset of a subject matter domain that corresponds to the corresponding first level category.

The method can include evaluator determining, for each first level category of the plurality of first level categories, a first level category membership score based on a similarity operation performed between a representative item for the respective first level category and remaining items of unstructured data within the respective first level category. The method can include the evaluator determining, for each second level category of the plurality of second level categories, a second level category membership score based on a similarity operation performed between a representative item for the respective second level category and remaining items of unstructured data within the respective second level category.

At ACT 212, the method 200 can include the one or more processors constructing a knowledge graph data structure linking the first plurality of categories with the corresponding second plurality of categories. The method can include the graph builder constructing, using the one or more generative artificial intelligence models, a knowledge graph data structure. The knowledge graph structure can link each of the plurality of first level categories and their respective first level subsets with their respective second level categories and the respective second level subsets within the respective first level subset, in order to relate each of the plurality of items of unstructured data with a corresponding first level category of the plurality of first level categories and a corresponding second level category of the plurality of second level categories according to the hierarchical data structure.

The method can include evaluating, via the one or more generative artificial intelligence models, each second level category of the plurality of second level categories according to one or more taxonomy criteria for the plurality of second level categories of the hierarchical data structure. The graph builder can construct the knowledge graph data structure, responsive to the evaluation of each second level category. The modifier can modify at least a second level category of the plurality of first level categories, responsive to the evaluation of each second level category.

The method can include the data processing system receiving, from a remote device, a query comprising content corresponding to a topic. The data processing system can identify, based on the content and the knowledge graph data structure, a first level category of the plurality of first level categories and a second level category of the plurality second level categories within the first level category. For instance, the classifier can identify any number of classifications in the knowledge graph data structure to identify the group of topics or a topic corresponding to the content of the query. The method can include the classifier selecting, based on the second level category, an item of the plurality of items corresponding to the topic. The data processing system can provide, to the remote device responsive to the query, a response based on the item.

The method can include the prompt generator providing, for at least one second level category of the plurality of second level categories, a third prompt to cause the one or more generative artificial intelligence models to output a plurality of third level categories for the respective second level category. The method can further include receiving, for each of the second level categories provided to the one or more generative artificial intelligence models, a plurality of third level categories, each third level category corresponding to a third level subset of items of unstructured data within a respective second level subset, the third level subset grouped according to a semantic similarity operation performed on the respective second level subset, and wherein the one or more processors further generate, using the one or more generative artificial intelligence models, a third layer label for each third level category based on context associated with the respective second level category and domain associated with the respective second level category.

FIGS. 3-7 are generally directed to examples of prompts and criteria that can be used in implementation of the technical solutions. FIG. 3 illustrates an example of a prompt 302 (e.g., a type of a prompt 122) providing various textual descriptions or instructions for the prompt. The prompt 302 can include, for example, descriptions or instructions for any of: a context for the prompt, an objective with associated examples, the style and tone, the audience of the taxonomy, or the response to be generated.

FIG. 4 illustrates a taxonomy criteria 402 to be used for generated category evaluation, including descriptions or instructions for accuracy, completeness, conciseness, clarity and consistency of the taxonomy. For instance, FIG. 4 is an illustrative example of taxonomy criteria 402 which can be used to evaluate output from a generative artificial intelligence model used to construct a knowledge graph. The taxonomy criteria display 400 can include criteria 402, which can be stored as a set of evaluation standards for use by an evaluator component. The criteria 402 can include accuracy, completeness, conciseness, clarity, or consistency, among others. In some implementations, the evaluator component can receive the criteria 402 as input and can apply the criteria 402 to assess the quality of a taxonomy generated by a generative artificial intelligence model.

The evaluator component can determine whether the definitions, descriptions of classes, properties, or individuals in the taxonomy are correct based on the accuracy criterion included in the criteria 402. The evaluator component can further determine whether all data can be reliably classified using the taxonomy based on the completeness criterion included in the criteria 402. In some implementations, the evaluator component can determine whether the taxonomy includes any irrelevant elements with regard to user intents in a customer service chat session based on the conciseness criterion included in the criteria 402. Each of the criteria can be evaluated using generative artificial intelligence models.

In some implementations, the evaluator component can determine whether the taxonomy communicates the intended meaning of the defined terms based on the clarity criterion included in the criteria 402. The evaluator component can determine whether the taxonomy includes or allows for any contradictions based on the consistency criterion included in the criteria 402. In some implementations, the evaluator component can generate an evaluation output indicating whether the taxonomy satisfies one or more of the criteria 402.

FIG. 5 illustrates an example of a taxonomy evaluation prompt 502 (e.g., a type of a prompt 122) providing descriptions or instructions for a generative artificial intelligence model to evaluate the output and provide suggestions for modifications, including example suggestions to provide for modifications. For example, FIG. 5 can illustrate a taxonomy evaluation prompt interface 500 that can be used to evaluate the output of a generative artificial intelligence model used to construct a knowledge graph. The taxonomy evaluation prompt interface can include an evaluation prompt 502.

The evaluation prompt 502 can be configured to instruct a generative artificial intelligence model to assess a taxonomy according to one or more specified criteria, such as accuracy, completeness, conciseness, clarity, or consistency, among others. The evaluation prompt 502 can specify that the generative artificial intelligence model is to identify any areas within the taxonomy that do not meet the criteria, provide suggestions for modifications or improvements, and ensure that the recommendations are mutually consistent and do not contradict one another. The evaluation prompt 502 can further specify that suggestions that can be actionable feedback based on major violations of the criteria (e.g., where criteria parameter exceeds a threshold by more than a tolerance or a percentage value), rather than minor details, and that suggestions can be based on the content of the taxonomy rather than general advice. The evaluation prompt 502 can provide an example of a suggestion, such as identifying overlap between categories like “Benefits and Enrollment” and “Retirement and 401K,” and can specify that the model should suggest merging categories to avoid redundancy. The evaluation prompt 502 can instruct the generative artificial intelligence model to output only the suggestions, and if the taxonomy satisfies the criteria, to output an indication such as “GOOD TAXONOMY.” The taxonomy evaluation prompt interface 500 can thereby provide a structured mechanism for evaluating and refining taxonomies generated by generative artificial intelligence models, based on explicit evaluation instructions and example feedback.

FIG. 6 illustrates an example of a modification prompt 602 (e.g., a type of prompt 122) providing descriptions or instructions for modifying the output per evaluation. The modification prompt 602 can provide instructions, descriptions, or corrections. For example, for title clarity modifications, example clarity modifications, or consistency modifications. For instance, FIG. 6 illustrates an output evaluation 600 from a generative artificial intelligence model, where the output evaluation 600 can include a modification prompt 602. In some implementations, the output evaluation 600 can include a textual assessment of a taxonomy generated by a generative artificial intelligence model. The output evaluation 600 can indicate that the taxonomy is generally well-structured and meets most of the criteria, while identifying areas for improvement related to clarity or consistency. For example, the output evaluation 600 can identify that the title for a merged new category for “Paycheck Advance” and “Early Wage Access” as they appear to overlap in meaning, as both refer to receiving wages before a scheduled payday.

In some implementations, the output evaluation 600 can include a modification prompt 602 that can specify a modification to merge the “Paycheck Advance” and “Early Wage Access” categories into a single category, such as “Early Wage Access/Paycheck Advance.” The modification prompt 602 can further indicate that the merged category can cover all examples previously provided in both categories. In some implementations, the output evaluation 600 can identify that an example provided in a “401k Loan Repayment” category, such as “How can I pay off my loan,” is vague and could fit into multiple categories. The modification prompt 602 can specify that the example can be made more specific, such as “How can I repay my 401k loan.”

In some implementations, the output evaluation 600 can further identify that a “401k Loan Balance” category includes a question about the payoff date, which could be considered part of the “401k Loan Repayment” category. The modification prompt 602 can specify that the example “What is the pay off date for my 401k loan” can be moved to the “401k Loan Repayment” category to maintain consistency. In some implementations, the output evaluation 600 can indicate that, after such modifications, the taxonomy can meet all criteria.

FIG. 7 illustrates another example of a modification prompt 602 (e.g., a type of a prompt 122) providing instructions or descriptions of modification suggestions to input into a generative artificial intelligence model and generate modified outputs. For instance, FIG. 7 is an illustrative example of a prompt for modifying a taxonomy using a generative artificial intelligence model. The taxonomy modification prompt example 700 can include a modification prompt 602 that can be provided to a generative artificial intelligence model in order to cause the generative artificial intelligence model to output a modified taxonomy. In some implementations, the modification prompt 602 can include a textual instruction that specifies the taxonomy format, the taxonomy to be modified, one or more taxonomy criteria, and a modification suggestion. The modification prompt 602 can specify that the generative artificial intelligence model is given a taxonomy in a particular taxonomy format, such as a hierarchical list, a tree structure, or a JSON object, among others. The modification prompt 602 can include a representation of the taxonomy, such as a set of categories and subcategories, or a hierarchical arrangement of topics, among others.

In some implementations, the modification prompt 602 can specify one or more taxonomy criteria that a well-structured taxonomy can meet, such as accuracy, completeness, conciseness, clarity, or consistency, among others. The modification prompt 602 can include an evaluation of the provided taxonomy based on the taxonomy criteria, such as a textual analysis or a set of metrics, among others. The modification prompt 602 can further include suggestions for modifications to improve the alignment of the taxonomy with the taxonomy criteria, such as merging categories, splitting categories, renaming categories, or reordering categories, among others.

In some implementations, the modification prompt 602 can instruct the generative artificial intelligence model to edit the taxonomy according to the modification suggestions. The modification prompt 602 can specify that the generative artificial intelligence model is to output only the modified taxonomy, without any preamble or tailpiece. The modification prompt 602 can be provided as input to the generative artificial intelligence model, and the output of the generative artificial intelligence model can include a modified taxonomy that reflects the suggested changes. The modified taxonomy can be evaluated by an evaluator component to determine whether the modified taxonomy satisfies the taxonomy criteria, or whether further modification is to be implemented.

FIG. 8A illustrates a method 800 of preparing and processing queries for taxonomy creation using generative artificial intelligence. The method 800 can be implemented using, for example, system 100 illustrated at FIG. 1, and can include actions or operations 802-866 shown in FIGS. 8A-8C. At. 802, the method can include receiving queries, where the query collector 106 can receive a plurality of queries from one or more client devices 140 over a network 101. The queries can include unstructured data, such as user-generated questions, feedback, or requests, among others. At 804, the method 800 can include sub-sampling, at which the query collector 106 can apply a sub-sampling operation to the received queries to reduce the data volume while maintaining a representative distribution of topics or intents. The sub-sampling operation can be based on a threshold corresponding to the number of queries or data volume, such that the resulting subset preserves the diversity of the original query set. At 806, the method 800 can include providing representative queries, where the query collector 106 can output the sub-sampled set of queries as representative queries for subsequent processing. The representative queries can be selected to include a range of topics, semantic variations, or user intents, among others.

At operation 808, the method 800 can include performing a training-test split, where the representative queries can be divided into a training set and a test set. The training-test split can be performed by the query collector 106 or another component of the data processing system 102, such that the training set can be used for taxonomy creation and the test set can be reserved for evaluation or validation. At 810, the method 800 can include providing training queries, where the training set of queries can be provided to the prompt generator 108 or classifier 110 for use in generating a taxonomy. At 812, the method 800 can include providing text queries, where the text of the queries can be formatted or pre-processed for compatibility with the generative artificial intelligence model 132. The formatted queries can be input to the generative artificial intelligence model 132 for category generation. At 814, the method 800 can include single-level taxonomy creation, where the classifier 110 can use the training queries to generate a single-level taxonomy by grouping the queries into categories based on semantic similarity or subject matter.

FIG. 8B is a flow diagram illustrating a method 820 for single-level taxonomy creation and query categorization using generative artificial intelligence, which in some implementations, can include operations that continue from the operation 814 at FIG. 8A. The method 820 can begin with the operation 810 of inputting training queries into the single-level taxonomy creation process 814, such as the one mentioned at FIG. 8A, but described in more detail in operations 824-840. The training queries inputting operation 810 can include identifying or providing a plurality of queries or items of unstructured data that can be used as input for taxonomy generation. At operation 814, the process flow 820 can proceed to single-level taxonomy creation, where the training queries inputting, at 810, can be provided to the single-level taxonomy creation 814 for generating categories for any of a plurality of levels in the multi-level hierarchical knowledge base data structure.

Within the single-level taxonomy creation 814, at operation 824, the process flow 820 can include level-specific taxonomy creation. The level-specific taxonomy creation can use one or more generative artificial intelligence models to generate a set of categories for the training queries input, at operation 810. At 826, the one or more models can output of the level-specific taxonomy, which can include the generated categories and their corresponding groupings of queries. At 828, the taxonomy can be provided for a taxonomy evaluation operation, where the determination or taxonomy for the set of categories is to be evaluated. In some implementations, the taxonomy evaluation can use one or more generative artificial intelligence models to assess the taxonomy according to one or more taxonomy criteria, such as accuracy, completeness, conciseness, clarity, or consistency, among others. The taxonomy evaluation, at operation 828, can determine whether the taxonomy, provided at operation 826, satisfies the taxonomy criteria or whether modifications are to be implemented.

At 830, if modifications are suggested, the process flow 820 can proceed to generating modification prompt for generative artificial intelligence models to generate the modified categories. In some implementations, the suggesting modifications can generate one or more proposed changes to the taxonomy based on the results of the taxonomy evaluation at operation 828. At 832, the process flow 820 can continue to modifying taxonomy, where the suggested modifications can be applied to the taxonomy to produce an updated taxonomy, which can be provided at operation 834.

The updated taxonomy, provided at operation 834, can be used for categorizing queries with taxonomy. At 834, the categorizing queries with taxonomy can assign the training queries to the categories defined in the updated taxonomy. The categorized queries can be inputted as inputting queries, which can be grouped by category at operation 838, where the queries can be organized according to their assigned categories.

The process flow 820 can conclude with returning result at operation 840. In some implementations, the returning result can provide the categorized queries, the taxonomy, or both, as output for further use in knowledge graph construction or intent classification.

The taxonomy creation method 850 illustrated in FIG. 8C can be performed by one or more processors to organize training queries using generative artificial intelligence models. The method 850 can utilize single-level taxonomy creation 814 as described in FIG. 8B for any number of category levels of the hierarchical data structure (e.g., the taxonomy). The process can begin with a single-level taxonomy creation 814, where the one or more processors can provide a prompt to a generative artificial intelligence model to perform an operation as part of method 850 to generate a first-level taxonomy 852 based on a plurality of training queries. The training queries can be grouped by top-level category at operation 854, according to the output of the generative artificial intelligence model.

Since single-level taxonomy creation can be utilized to sub-categorize a plurality of categories within a particular level, the one or more processors can perform multiple single-level taxonomy creations 814, including a single-level taxonomy creation 814a for each first-level category identified in the first-level taxonomy 852 and a single-level taxonomy creation 814b for another sub-category. The generative artificial intelligence model can generate a second-level taxonomy at operation 856a for a first-level category, and the training queries can be grouped by category 858a according to the second-level taxonomy, at 856a. The one or more processors can perform a single-level taxonomy creation for another first-level category, where the generative artificial intelligence model can generate a second-level taxonomy, at 856b, and the training queries can be grouped by category, at 858b, according to the second-level taxonomy 856b.

In some implementations, the one or more processors can further perform a single-level taxonomy creation 814 on the training queries grouped by category, at 858a or at 858b. The generative artificial intelligence model can generate, via single-level taxonomy creation 814, a third-level taxonomy 860, and the training queries can be grouped by category 862 according to the third-level taxonomy 860. The one or more processors can perform an additional single-level taxonomy creation 814 on the training queries grouped by category, at 862, and the generative artificial intelligence model can generate a fourth-level taxonomy, at operation 864, and the training queries can be grouped by category, at 866, according to the fourth-level taxonomy 864.

In some implementations, each step of the taxonomy creation process 850 can include evaluating the generated taxonomy at each level using taxonomy criteria, such as accuracy, completeness, conciseness, clarity, or consistency, among others, prior to proceeding to the next level of taxonomy creation. The process can be repeated for any number of levels, such that the taxonomy creation process 850 can generate a multi-level taxonomy that organizes the training queries into progressively finer categories based on semantic similarity as determined by the generative artificial intelligence model.

For example, the data processing system can identify queries. The data processing system (e.g., via query collector) can sample queries to identify representative queries. The data processing system can subsample queries when the number of queries or data volume is greater than a threshold. The subsampler can generate a smaller yet representative data set from the original large data set of queries, such that important topics or implicate details are not lost, thereby maintaining the accuracy and reliability of the taxonomy generated from the subsampled query data set.

FIG. 9 illustrates a block diagram of a computing system 900 for implementing the embodiments of the technical solutions discussed herein, in accordance with various aspects. FIG. 9 illustrates a block diagram of an example computing system 900, which can also be referred to as the computer system 900. Computing system 900 can be used to implement elements of the systems and methods described and illustrated herein. Computing system 900 can be included in and run any device (e.g., a server, a computer, a cloud computing environment or a data processing system).

Computing system 900 can include at least one bus data bus 905 or other communication device, structure or component for communicating information or data. Computing system 900 can include at least one processor 910 or processing circuit coupled to the data bus 905 for executing instructions or processing data or information. Computing system 900 can include one or more processors 910 or processing circuits coupled to the data bus 905 for exchanging or processing data or information along with other computing systems 900. Computing system 900 can include one or more non-transitory computer readable media, such as main memories 915, such as a random access memory (RAM), dynamic RAM (DRAM), cache memory or other dynamic storage device, which can be coupled to the data bus 905 for storing information, data and instructions to be executed by the processor(s) 910. Main memory 915 can be used for storing information (e.g., data, computer code, commands or instructions) during execution of instructions by the processor(s) 910.

Computing system 900 can include one or more read only memories (ROMs) 920 or other static storage device 925 coupled to the bus 905 for storing static information and instructions for the processor(s) 910. Storage devices 925 can include any storage device, such as a solid state device, magnetic disk or optical disk, which can be coupled to the data bus 905 to persistently store information and instructions.

Computing system 900 can be coupled via the data bus 905 to one or more output devices 935, such as speakers or displays (e.g., liquid crystal display or active matrix display) for displaying or providing information to a user. Input devices 930, such as keyboards, touch screens or voice interfaces, can be coupled to the data bus 905 for communicating information and commands to the processor(s) 910. Input device 930 can include, for example, a touch screen display (e.g., output device 935). Input device 930 can include a cursor control, such as a mouse, a trackball, or cursor direction keys, for communicating direction information and command selections to the processor(s) 910 for controlling cursor movement on a display.

The processes, systems and methods described herein can be implemented by the computing system 900 in response to the processor 910 executing an arrangement of instructions contained in main memory 915. Such instructions can be read into main memory 915 from another computer-readable medium, such as the storage device 925. Execution of the arrangement of instructions contained in main memory 915 causes the computing system 900 to perform the illustrative processes described herein.

One or more processors 910 in a multi-processing arrangement may also be employed to execute the instructions contained in main memory 915. Hard-wired circuitry can be used in place of or in combination with software instructions together with the systems and methods described herein. Systems and methods described herein are not limited to any specific combination of hardware circuitry and software.

Although an example computing system has been described in FIG. 9, the subject matter including the operations described in this specification can be implemented in other types of digital electronic circuitry, or in computer software, firmware, or hardware, including the structures disclosed in this specification and their structural equivalents, or in combinations of one or more of them.

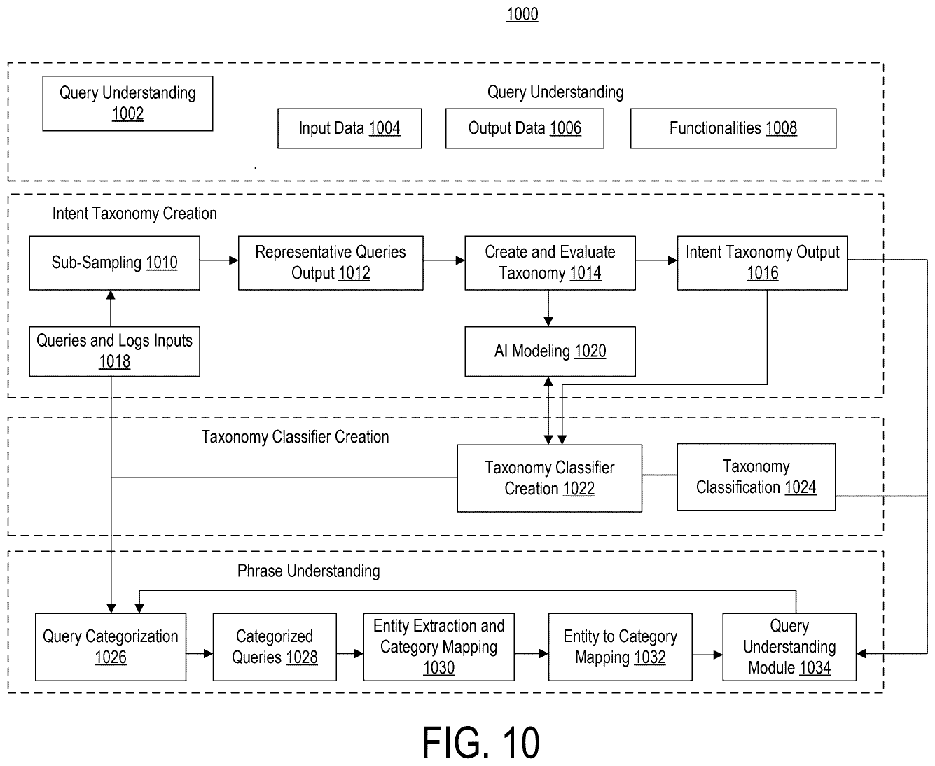

FIG. 10 illustrates a diagram of an example system 1000 for determining or analyzing queries, taxonomy creation and classification, and phrase understanding. The system 1000 can be configured to implement a query understanding function 1002, which can be realized as a module or collection of modules. The system 1000 can include, for example, an intent taxonomy creation function, a taxonomy classifier creation function, and a phrase understanding function, each of which can be implemented using, or incorporate any features of, one or more components or functionalities of system 100 depicted in FIG. 1, such as the data processing system 102 and the generative AI model 132.

In operation, the system 1000 can receive input data 1004 comprising user queries or utterances, which can be collected from various sources such as client devices or data repositories, which can include various input data 1004, output data 1006 and functionalities 1008. The input data 1004 can be provided to an intent taxonomy creation module, which utilizes generative artificial intelligence models to analyze the queries and generate a multi-level taxonomy or ontology that organizes the queries into hierarchical categories and sub-categories based on semantic similarity and subject matter relevance.

The intent taxonomy creation can include queries and log inputs operations 1018 into sub-sampling operations at 1010 to provide representative queries output, at operation 1012, and to create and evaluate taxonomy, at 1014, for intent taxonomy output provided at 1016. The creation and evaluation of taxonomy can be implemented using AI modeling, at operation 1020, where model, such as generative artificial intelligence models 132, can be utilized.

The generated taxonomy, from the taxonomy output 1016, can be provided to a taxonomy classifier creation 1022. This module is configured to provide, train or update taxonomy classification, at 1024, using the taxonomy and the categorized queries, and allowing the system to map new or incoming queries to the appropriate intent categories within the taxonomy. The classifier creation can evaluate the performance of the classifier using validation data and iteratively refine the taxonomy or classifier parameters to improve accuracy.

The system 1000 further includes a phrase understanding module, which can be designed to extract and interpret the underlying intent, entities, or contextual information from user queries. This phrase understanding may utilize a series of functions to use the taxonomy and classifier outputs to disambiguate user intent, resolve follow-up questions, and support advanced natural language understanding tasks such as entity extraction, slot filling, or contextual query rewriting. For example, the phrase understanding can receive query categorization at 1026, such as from queries and logs inputs at 1018. Categorized queries identified at 1028, can receive query categorizations from 1026 and utilize entity extraction and category mapping at operation 1030 to provide entity to category mapping at 1032 and provide the output to the query understanding module, at 1034.

Throughout the process, data flows between the modules according to the arrows depicted in the diagram. Input queries can be first processed by the taxonomy creation module, which can output a taxonomy to the classifier creation module. The classifier creation module can output a trained classifier and classification results, which can be utilized by the phrase understanding module to enable downstream applications such as intelligent routing, response generation, or analytics. The system 1000 can further provide feedback or evaluation results to earlier modules, supporting iterative refinement of the taxonomy, classifier, or phrase understanding logic.

In some implementations, the system 1000 can operate in conjunction with or as an extension of the data processing system 102 and generative AI model 132 described in FIG. 1, leveraging shared data repositories, models, or computational resources to enable scalable and adaptive query understanding across a variety of domains and use cases.

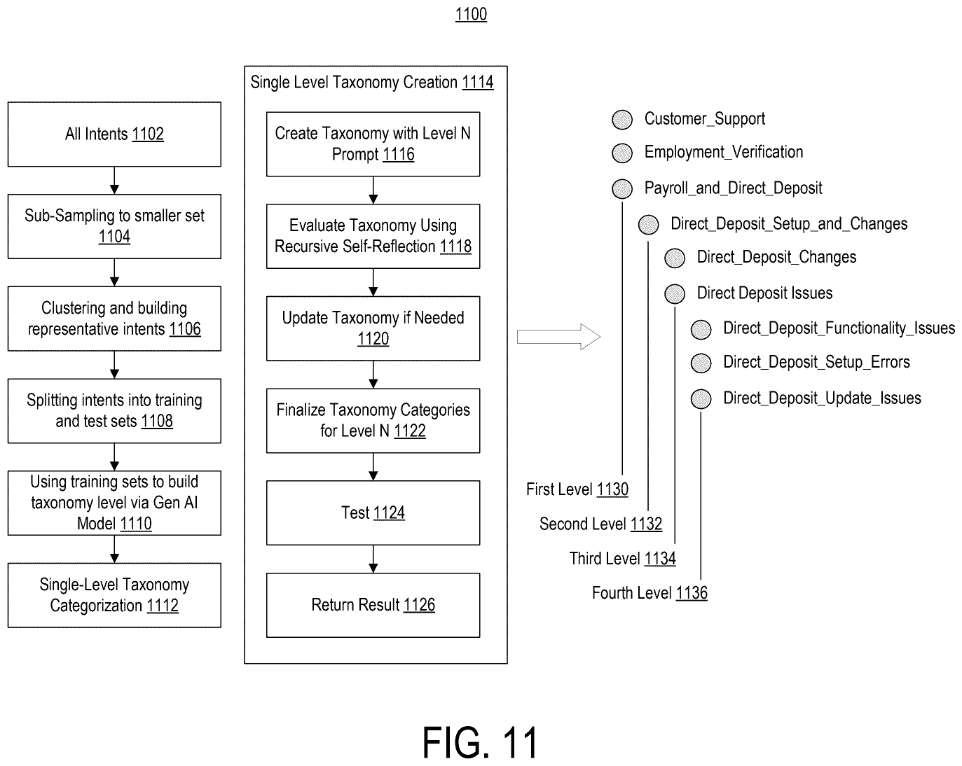

FIG. 11 can illustrate a flow diagram of a method for constructing a knowledge graph using a generative artificial intelligence model. In some implementations, the method depicted in FIG. 11 can be performed by one or more processors. The method can begin at step 1102, where the one or more processors can receive a plurality of unstructured user queries directed to various intents. The unstructured user queries can include, for example, chat transcripts, search logs, or customer service tickets, among others. The one or more processors can store the unstructured user queries in a data repository.

At step 1104, the one or more processors can perform a sub-sampling operation on the received unstructured user queries. The sub-sampling operation can reduce the data volume while maintaining a representative distribution of topics or intents. The sub-sampled set can be output as representative queries for subsequent processing.

At step 1106, the one or more processors can cluster the data and build representative intents. For instance, the system can split the representative queries into a training set and a test set. The training set can be used for taxonomy creation, and the test set can be reserved for evaluation or validation.

At step 1108, the one or more processors can split intents into training and test sets and provide the training set of queries for using for building taxonomy levels. The training and test sets can be used for different category levels. The prompt generator can generate a taxonomy prompt, such as prompt 302, for input to a generative artificial intelligence model. The taxonomy prompt can include instructions for generating a particular single-level taxonomy, a dataset of representative queries, and, optionally, an existing taxonomy for reference.

At step 1110, the one or more processors can use the training sets to build taxonomy levels via generative artificial intelligences models. For instance, the method can provide the taxonomy prompt and the training set of queries to the generative artificial intelligence model. The generative artificial intelligence model can output a set of categories at a first level of a hierarchical taxonomy. The categories can include broad topics, such as payroll, benefits, or time off, among others.

At step 1112, the one or more processors can provide the single-level taxonomy categorization. For instance, the method can evaluate the generated categories using taxonomy criteria. The taxonomy criteria can include, for example, accuracy, completeness, conciseness, clarity, or consistency, among others. The evaluation can be performed by an evaluator, which can use a generative artificial intelligence model to assess the generated categories according to the taxonomy criteria.

At step 1114, the one or more processors can implement the single-level taxonomy creation, such as the one implemented in FIG. 8B, to establish categories and group the data for different category levels. The method can generate and evaluate the categories. The method can determine whether the generated categories satisfy the taxonomy criteria. If the categories do not satisfy the taxonomy criteria, the one or more processors can modify the categories. The modification can include merging, splitting, or removing categories, reassigning queries, or assigning new labels, among others. The one or more processors can re-evaluate the modified categories until the taxonomy criteria are satisfied.

More specifically, at step 1116, the one or more processors can proceed to generate sub-categories for each category at a particular level, such as the first level. The one or more processors can generate a new taxonomy prompt for each category, provide the prompt and the corresponding subset of queries to the generative artificial intelligence model, and receive a set of sub-categories at a second level. The one or more processors can evaluate and, if necessary, modify the sub-categories using the taxonomy criteria.

At step 1118, the one or more processors can evaluate taxonomy using recursive self-reflection. For instance, the method can repeat the process of generating, evaluating, and modifying sub-categories for additional levels of the taxonomy, as preferred. The process can continue until the desired number of levels or the desired granularity is achieved (e.g., a desired number of categories, with a desired or satisfactory parameters for accuracy, completeness, conciseness, clarity and consistency, each of which can have their own parameter threshold range to be satisfied in the evaluation and modification stage).

At step 1120, the one or more processors can update the taxonomy as preferred to satisfy the criteria conditions (e.g., accuracy, completeness, conciseness, clarity and consistency) and can construct a knowledge graph data structure using the generated taxonomy. The knowledge graph data structure can link each category and sub-category across the multiple levels, and associate each query with its corresponding categories in the hierarchy.

At step 1122, the one or more processors can finalize the taxonomy for the given levels. For instance, the method can finalize the categorization and provide, for example, a first level 1130 category corresponding to “customer_support”, “employment_verification”, and “payroll_and_direct_deposit” categories. Within the “payroll_and_direct_deposit” category, the method can generate a sub-category (e.g., second level category 1132) of “direct_deposit_setup_and_changes”, which can further include third-level sub-categories 1134 of “direct_deposit_changes” and “direct_deposit_issues”. Further, within the “third_deposit_issues” sub-category 1134, the method can generate fourth-level sub-categories 1136 of “direct_deposit_functionality_issues”, “direct_deposit_setup_errors”, and “direct_deposit_update_issues.”

The foregoing examples have been provided merely for the purpose of explanation and are in no way to be construed as limiting of the present description. While aspects of the present description have been described with reference to different examples, it is understood that the words which have been used herein are words of description and illustration, rather than words of limitation. Changes may be made, within the purview of the appended claims, as presently stated and as amended, without departing from the scope and spirit of the present description in its aspects. Although aspects of the technical solutions described herein have been described with reference to particular means, materials and embodiments, the present technical solutions are not intended to be limited to the particulars described herein; rather, the present description extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present application.

1. A system, comprising:
one or more processors, coupled with memory, to:
identify a plurality of items of unstructured data;
provide, for one or more generative artificial intelligence models, a first prompt to cause the one or more generative artificial intelligence models to output a plurality of first level categories of a hierarchical data structure for the plurality of items;
receive, responsive to the first prompt and the plurality of items input into the one or more generative artificial intelligence models, the plurality of first level categories, each first level category of the plurality of first level categories corresponding to a respective first level subset of the plurality of items, the first level subset grouped according to a semantic similarity operation performed on the plurality of items;
evaluate, via the one or more generative artificial intelligence models, each first level category of the plurality of first level categories according to one or more taxonomy criteria for the plurality of first level categories of the hierarchical data structure;
provide, responsive to the evaluation, for the one or more generative artificial intelligence models, a second prompt to cause the one or more generative artificial intelligence models to output a plurality of second level categories of the hierarchical data structure for each first level category of the plurality of first level categories;
receive, for each first level category, responsive to the second prompt input into the one or more generative artificial intelligence models, the plurality of second level categories, each second level category of the plurality of second level categories corresponding to a respective second level subset of the plurality of items of unstructured data within a corresponding first level subset of the respective first level category, the second level subset grouped according to a semantic similarity operation performed on the respective first level subset; and
construct, using the one or more generative artificial intelligence models, a knowledge graph data structure that links each of the plurality of first level categories and their respective first level subsets with second level categories and respective second level subsets within the respective first level subset to relate each of the plurality of items of unstructured data with a corresponding first level category of the plurality of first level categories and a corresponding second level category of the plurality of second level categories according to the hierarchical data structure.

2. The system of claim 1, wherein the one or more processors further:
receive, from a remote device, a query comprising content corresponding to a topic;
identify, based on the content and the knowledge graph data structure, a first level category of the plurality of first level categories and a second level category of the plurality second level categories within the first level category;
select, based on the second level category, an item of the plurality of items corresponding to the topic; and
provide, to the remote device responsive to the query, a response based on the item.

3. The system of claim 1, wherein the one or more processors further:
modify, responsive to the evaluation, at least a first level category of the plurality of first level categories to satisfy the one or more taxonomy criteria; and
provide the second prompt for the one or more generative artificial intelligence models, responsive to confirmation that each first level category of the plurality of first level categories satisfies the one or more taxonomy criteria.

4. The system of claim 1, wherein the one or more processors further:
evaluate, via the one or more generative artificial intelligence models, each second level category of the plurality of second level categories according to one or more taxonomy criteria for the plurality of second level categories of the hierarchical data structure; and
construct the knowledge graph data structure, responsive to the evaluation of each second level category.

5. The system of claim 4, wherein the one or more processors further modify, at least a second level category of the plurality of first level categories, responsive to the evaluation of each second level category.

6. The system of claim 1, wherein the taxonomy criteria comprise at least one of: a threshold corresponding to a proportion of the plurality of items assigned to at least one of the first level categories and the second level categories, an inter-model agreement score determined from parallel classifications by two or more generative artificial intelligence models, a category size threshold corresponding to a number of items grouped in each category of the second level categories, a label clarity threshold corresponding to unambiguity of category labels within a subject matter domain, or a category overlap threshold corresponding to a limitation of a number of items of the plurality of items that are assigned to more than one category within a hierarchy level.

7. The system of claim 1, wherein the one or more processors further:
generate an embedding vector for each item of the plurality of items of unstructured data using machine learning; and
group subsets of the plurality of items based on a similarity metric applied to the embedding vectors during the semantic similarity operation.

8. The system of claim 1, wherein the first prompt comprises a representation of at least one example taxonomy or an example knowledge graph data structure.

9. The system of claim 1, wherein the one or more processors further:
generate, using the one or more generative artificial intelligence models, a first layer label for each first level category of the plurality of first level categories based on a subject matter associated with the plurality of items of unstructured data within the corresponding first level subset; and
generate, using the one or more generative artificial intelligence models, a second layer label for each second level category of the plurality of second level categories based on a context of the corresponding first level category to which the second level category belongs and a subset of a subject matter domain that corresponds to the corresponding first level category.

10. The system of claim 1, wherein the one or more processors further:
determine, for each first level category of the plurality of first level categories, a first level category membership score based on a similarity operation performed between a representative item for the respective first level category and remaining items of unstructured data within the respective first level category; and
determine, for each second level category of the plurality of second level categories, a second level category membership score based on a similarity operation performed between a representative item for the respective second level category and remaining items of unstructured data within the respective second level category.

11. The system of claim 10, wherein the one or more processors further:
compare each first level category membership score to a first threshold value and, for each first level category with a membership score below the first threshold value, modify the respective first level category; and
compare each second level category membership score to a second threshold value and, for each second level category with a membership score below the second threshold value, modify the respective second level category.

12. The system of claim 11, wherein the modification of the respective first level category or the second level category includes at least one of: merging the respective category with a related category, splitting the respective category into two or more categories, removing the respective category, reassigning one or more items to a different category, or assigning a new label to the respective category.

13. The system of claim 1, wherein the one or more processors further:
provide, for at least one second level category of the plurality of second level categories, a third prompt to cause the one or more generative artificial intelligence models to output a plurality of third level categories for the respective second level category.

14. The system of claim 13, wherein the one or more processors further:
receive, for each of the second level categories provided to the one or more generative artificial intelligence models, a plurality of third level categories, each third level category corresponding to a third level subset of items of unstructured data within a respective second level subset, the third level subset grouped according to a semantic similarity operation performed on the respective second level subset.

15. The system of claim 13, wherein the one or more processors further:
generate, using the one or more generative artificial intelligence models, a third layer label for each third level category based on context associated with the respective second level category and domain associated with the respective second level category.

16. A method, comprising:
identifying, by one or more processors coupled with memory, a plurality of items of unstructured data;
providing, by the one or more processors, for one or more generative artificial intelligence models, a first prompt to cause the one or more generative artificial intelligence models to output a plurality of first level categories of a hierarchical data structure for the plurality of items;
receiving, by the one or more processors, responsive to the first prompt and the plurality of items input into the one or more generative artificial intelligence models, the plurality of first level categories, each first level category of the plurality of first level categories corresponding to a respective first level subset of the plurality of items, the first level subset grouped according to a semantic similarity operation performed on the plurality of items;
evaluating, by the one or more processors, via the one or more generative artificial intelligence models, each first level category of the plurality of first level categories according to one or more taxonomy criteria for the plurality of first level categories of the hierarchical data structure;
providing, by the one or more processors, responsive to the evaluation, for the one or more generative artificial intelligence models, a second prompt to cause the one or more generative artificial intelligence models to output a plurality of second level categories of the hierarchical data structure for each first level category of the plurality of first level categories;
receiving, by the one or more processors, for each first level category, responsive to the second prompt input into the one or more generative artificial intelligence models, the plurality of second level categories, each second level category of the plurality of second level categories corresponding to a respective second level subset of the plurality of items of unstructured data within a corresponding first level subset of the respective first level category, the second level subset grouped according to a semantic similarity operation performed on the respective first level subset; and
constructing, by the one or more processors, using the one or more generative artificial intelligence models, a knowledge graph data structure that links each of the plurality of first level categories and their respective first level subsets with second level categories and respective second level subsets within the respective first level subset to relate each of the plurality of items of unstructured data with a corresponding first level category of the plurality of first level categories and a corresponding second level category of the plurality of second level categories according to the hierarchical data structure.

17. The method of claim 16, comprising
receiving, by the one or more processors, from a remote device, a query comprising content corresponding to a topic;
identifying, by the one or more processors, based on the content and the knowledge graph data structure, a first level category of the plurality of first level categories and a second level category of the plurality second level categories within the first level category;
selecting, by the one or more processors, based on the second level category, an item of the plurality of items corresponding to the topic; and
providing, by the one or more processors, to the remote device responsive to the query, a response based on the item.

18. The method of claim 16, comprising:
modifying, by the one or more processors, responsive to the evaluation, at least a first level category of the plurality of first level categories to satisfy the one or more taxonomy criteria; and
providing, by the one or more processors, the second prompt for the one or more generative artificial intelligence models, responsive to confirmation that each first level category of the plurality of first level categories satisfies the one or more taxonomy criteria.

19. The method of claim 16, comprising:
evaluating, by the one or more processors, via the one or more generative artificial intelligence models, each second level category of the plurality of second level categories according to one or more taxonomy criteria for the plurality of second level categories of the hierarchical data structure; and
constructing, by the one or more processors, the knowledge graph data structure, responsive to the evaluation of each second level category.

20. A non-transitory computer readable media storing instructions, which when executed by one or more processors, cause the one or more processors to:
identify a plurality of items of unstructured data;
provide, for one or more generative artificial intelligence models, a first prompt to cause the one or more generative artificial intelligence models to output a plurality of first level categories of a hierarchical data structure for the plurality of items;
receive, responsive to the first prompt and the plurality of items input into the one or more generative artificial intelligence models, the plurality of first level categories, each first level category of the plurality of first level categories corresponding to a respective first level subset of the plurality of items, the first level subset grouped according to a semantic similarity operation performed on the plurality of items;
evaluate, via the one or more generative artificial intelligence models, each first level category of the plurality of first level categories according to one or more taxonomy criteria for the plurality of first level categories of the hierarchical data structure;
provide, responsive to the evaluation, for the one or more generative artificial intelligence models, a second prompt to cause the one or more generative artificial intelligence models to output a plurality of second level categories of the hierarchical data structure for each first level category of the plurality of first level categories;
receive, for each first level category, responsive to the second prompt input into the one or more generative artificial intelligence models, the plurality of second level categories, each second level category of the plurality of second level categories corresponding to a respective second level subset of the plurality of items of unstructured data within a corresponding first level subset of the respective first level category, the second level subset grouped according to a semantic similarity operation performed on the respective first level subset; and
construct, using the one or more generative artificial intelligence models, a knowledge graph data structure that links each of the plurality of first level categories and their respective first level subsets with second level categories and respective second level subsets within the respective first level subset to relate each of the plurality of items of unstructured data with a corresponding first level category of the plurality of first level categories and a corresponding second level category of the plurality of second level categories according to the hierarchical data structure.
